(19) United States
(12) Patent Application Publication
(10) Pub. No.: US 2023/0182315 A1
(43) Pub. Date: Jun. 15, 2023

(54) SYSTEMS AND METHODS FOR OBJECT DETECTION AND PICK ORDER DETERMINATION

(71) Applicant: Boston Dynamics, Inc., Waltham, MA (US)

(72) Inventors: Lukas Merkle, Cambridge, MA (US); Matthew Turpin, Newton, MA (US); Samuel Shaw, Somerville, MA (US); Andrew Hoelscher, Somerville, MA (US); Rebecca Khurshid, Cambridge, MA (US); Laura Lee, Cambridge, MA (US); Colin Snow, Sharon, MA (US)

(73) Assignee: Boston Dynamics, Inc., Waltham, MA (US)

(21) Appl. No.: 18/072,863

(22) Filed: Dec. 1, 2022

Related U.S. Application Data
(60) Provisional application No. 63/288,368, filed on Dec. 10, 2021.

(51) Int. Cl. B25J 9/16; B25J 19/02; G06T 17/00

(52) U.S. Cl. CPC B25J 9/1697; B25J 9/1669; B25J 19/023; G06T 17/00

(57) ABSTRACT

Methods and apparatus for object detection and pick order determination for a robotic device are provided. Information about a plurality of two-dimensional (2D) object faces of the objects in the environment may be processed to determine whether each of the plurality of 2D object faces matches a prototype object of a set of prototype objects stored in a memory, wherein each of the prototype objects in the set represents a three-dimensional (3D) object. A model of 3D objects in the environment of the robotic device is generated using one or more of the prototype objects in the set of prototype objects that was determined to match one or more of the 2D object faces.

### CROSS REFERENCE TO RELATED APPLICATIONS

This application claims the benefit under 35 U.S.C. § 119(e) of U.S. Provisional application Ser. No. 63/288,368, filed Dec. 10, 2021, and entitled, “SYSTEMS AND METHODS FOR OBJECT DETECTION AND PICK ORDER DETERMINATION,” the disclosure of which is incorporated by reference in its entirety.

### BACKGROUND

A robot is generally defined as a reprogrammable and multifunctional manipulator designed to move material, parts, tools, or specialized devices through variable programmed motions for a performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

### SUMMARY

When picking objects (e.g., boxes) from a stack of objects (e.g., in a truck and to be unloaded into a warehouse), a robot needs to select which object it should pick next. While choosing top-most objects in the stack to pick next may be a reasonable choice, as it is unlikely picking such objects will cause other objects in the stack to shift or fall, sometimes it may not be possible to remove all of the objects at the top of the stack (e.g., boxes that are not within reach of the manipulator of the robot) before moving on to lower objects in the stack. For a stack that is deep, removing objects closest to the robot first, may also be reasonable. However, objects may not always be stacked in such a way that they can be removed in this order without knocking other objects in the stack over. Some embodiments relate to determining and maintaining a set of object candidates (also referred to herein as “prototypes”) that can be used to identify objects in a stack to facilitate a determination of which object to pick next.

A robot configured to pick objects from a stack often includes a perception system that captures images of the stack in front of the robot and can perceive surfaces (e.g., box faces) of the objects in the stack. Often there is incomplete information available to the robot as only some of the object surfaces (e.g., the front face of the object facing the robot) can be observed using the perception system. If the dimensions of all of the objects in the stack are the same known size, it is possible to predict the depth of an object from a 2-dimensional face using the remaining dimension. However, if there are multiple possible dimensions of objects in the stack, the same detected object surface may correspond to multiple object candidates. Overlap of objects in a stack having different size objects can be challenging for a robot to detect based on two-dimensional images captured by the robot's perception system. Some embodiments relate to techniques for determining a dimension of an object that cannot be observed from a two-dimensional image of the object surface by picking and/or rotating the object such that the missing dimension can be perceived with a robot's perception system.

After an object is grasped by a robot, the robot may determine how to place the object at a desired location. For instance in a typical pick and place operation the robot may grasp an object from a first location (e.g., from a stack of objects in a truck) and place the object at a second location (e.g., on a conveyor coupled to or located near the robot) by releasing the object from the robot's grasp. More particularly, it may be desirable to place the object at the second location with the object having a particular orientation relative to one or more other objects at the second location. As an example, when the robot is tasked with placing objects on a conveyor, it may be advantageous to place objects on the conveyor in an orientation that will reduce or minimize the risk that the object falls off of the conveyor and/or that the object (or its contents) are otherwise damaged. For instance, the object may be placed on the conveyor with its longest dimension aligned with the plane of the conveyor. Some embodiments relate to using information (e.g., dimension information) about a grasped object to determine how to place the object in a desired orientation.

One aspect of the present disclosure provides a method of generating a model of objects in an environment of a robotic device. The method comprises receiving, by at least one computing device, information about a plurality of two-dimensional (2D) object faces of the objects in the environment, determining, by the at least one computing device, based at least in part on the information, whether each of the plurality of 2D object faces matches a prototype object of a set of prototype objects stored in a memory accessible to the at least one computing device, wherein each of the prototype objects in the set represents a three-dimensional (3D) object, and generating, by the at least one computing device, a model of 3D objects in the environment using one or more of the prototype objects in the set of prototype objects that was determined to match one or more of the 2D object faces.

In another aspect, the method further comprises determining that a first 2D object face of the plurality of 2D object faces does not match any prototype object in the set of prototype objects, creating a new prototype object for the first 2D object face that does not match any prototype object in the set, and adding the new prototype object to the set of prototype objects.

In another aspect, the method further comprises controlling the robotic device to pick up the object associated with the first 2D object face, and capture one or more images of the picked-up object, wherein the one or more images include at least one face of the object other than the first 2D object face, and wherein the new prototype object is created based, at least in part, on the captured one or more images of the picked-up object.

In another aspect, the method further comprises controlling the robotic device to rotate the picked-up object prior to capturing the one or more images of the picked-up object.

In another aspect, creating the new prototype object based, at least in part, on the captured one or more images comprises identifying a first planar surface in a first image of the captured one or more images, and calculating a dimension of the picked-up object based on the first planar surface, wherein the new prototype object includes the calculated dimension.

In another aspect, identifying a first planar surface in the first image comprises using a region growing technique to identify the first planar surface.

In another aspect, creating the new prototype object based, at least in part, on the captured one or more images further comprises fitting a rectangle to the first planar surface identified in the first image and calculating the dimension of the picked-up object based on the fitted rectangle.

In another aspect, the method further comprises identifying a plurality of planar surfaces in the captured image, and identifying the first planar surface as a largest planar surface of the plurality of planar surfaces.

In another aspect, creating the new prototype object based, at least in part, on the captured one or more images comprises detecting one or more features of the at least one face of the object other than the first 2D object face of the object in a first image of the captured one or more images, and associating the one or more features with the created new prototype object.

In another aspect, the one or more features include one or both of a texture of the at least one face and a color of the at least one face.

In another aspect, the set of prototype objects does not include any prototype objects.

In another aspect, the method further comprises receiving user input describing prototype objects to include in the set of prototype objects, and populating the set of prototype objects with prototype objects based on the user input.

In another aspect, the method further comprises receiving, from a computer system, input describing prototype objects to include in the set of prototype objects, and populating the set of prototype objects with prototype objects based on the input. In another aspect, the computing system is a warehouse management system.

In another aspect, the method further comprises determining a set of pickable objects based, at least in part, on the generated model of 3D objects, selecting a target object from the set of pickable objects, and controlling the robotic device to grasp the target object.

In another aspect, the method further comprises determining interactions between objects in the generated model of 3D objects and another object in the environment of the robotic device, filtering the set of pickable objects based, at least in part, on the determined interactions, and selecting the target object from the filtered set of pickable objects.

In another aspect, determining interactions between objects in the generated model of 3D objects comprises determining which objects in the generated model have extraction constraints dependent on extraction of one or more other objects in the generated model, and filtering the set of pickable objects comprises including in the filtered set of pickable objects, only objects in the generated model that do not have extraction constraints dependent on extraction of one or more other objects in the generated model.

In another aspect, an object in the generated model is determined to have an extraction constraint when another object in the generated model is located above the object.

In another aspect, the another object comprises an object not in the generated model of 3D objects.

In another aspect, the another object comprises one or more of a wall or a ceiling of an enclosure in the environment of the robotic device.

In another aspect, determining interactions between objects in the generated model of 3D objects and another object is based at least in part on at least one potential extraction trajectory associated with the objects in the generated model.

In another aspect, the method further comprises determining a reserved space through which the at least one potential extraction trajectory will travel, and including, in the filtered set of pickable objects, only objects in the generated model that have a corresponding reserved space in which no other objects are present.

In another aspect, the reserved space is a space above and toward the robotic device.

In another aspect, the method further comprises determining based, at least in part, on the information, that a first 2D object face of the plurality of 2D object faces matches multiple prototype objects in the set of prototype objects, and determining interactions between objects in the generated model of 3D objects and another object comprises determining, for each of the multiple prototype objects matching the first 2D object face, interactions between the prototype object and another object.

In another aspect, the method further comprises determining whether the grasped target object is associated with a prototype object in the set of prototype objects, and creating a prototype object for the grasped target object when it is determined that the grasped target object is not associated with a prototype object in the set of prototype objects.

Another aspect of the present disclosure provides a robotic device. The robotic device comprises a robotic arm having disposed thereon, a suction-based gripper configured to grasp a target object, a perception system configured to capture one or more images of a plurality of two-dimensional (2D) object faces of objects in an environment of the robotic device, and at least one computing device configured to determine based, at least in part, on the captured one or more images, whether each of the plurality of 2D object faces matches a prototype object of a set of prototype objects stored in a memory of the robotic device, wherein each of the prototype objects in the set represents a three-dimensional (3D) object, generate a model of 3D objects in the environment using one or more of the prototype objects in the set of prototype objects that was determined to match one or more of the 2D object faces, select based, at least in part, on the generated model, one of the objects in the environment as a target object, and control the robotic arm to grasp the target object.

In another aspect, the at least one computing device is further configured to determine that a first 2D object face of the plurality of 2D object faces does not match any prototype object in the set of prototype objects, create a new prototype object for the first 2D object face that does not match any prototype object in the set, and add the new prototype object to the set of prototype objects.

In another aspect, the at least one computing device is further configured to control the robotic arm to pick up the object associated with the first 2D object face, and control the perception system to capture one or more images of the picked-up object, wherein the one or more images include at least one face of the object other than the first 2D object face, wherein the new prototype object is created based, at least in part, on the captured one or more images of the picked-up object.

In another aspect, the at least one computing device is further configured to control the robotic arm to rotate the picked-up object prior to capturing the one or more images of the picked-up object by the perception system.

In another aspect, the set of prototype objects does not include any prototype objects.

In another aspect, the robotic device further comprises a user interface configured to enable a user to provide user input describing prototype objects to include in the set of prototype objects, and the at least one computing device is further configured to populate the set of prototype objects with prototype objects based on the user input.

In another aspect, the at least one computing device is further configured to receive, from a computer system, input describing prototype objects to include in the set of prototype objects, and populate the set of prototype objects with prototype objects based on the input. In another aspect, the computing system is a warehouse management system.

In another aspect, the at least one computing device is further configured to determine a set of pickable objects based, at least in part, on the generated model of 3D objects, select a target object from the set of pickable objects, and control the robotic arm to grasp the target object.

In another aspect, the at least one computing device is further configured to determine a desired orientation of the target object, and place the target object in the desired orientation at a target location.

In another aspect, determining the desired orientation of the target object is based, at least in part, on the target location.

In another aspect the target location includes a conveyor, and determining the desired orientation of the target object comprises determining to align a longest axis of the target object with a length dimension of the conveyor.

In another aspect, the at least one computing device is further configured to determine the longest axis of the target object based on at least one of the one or more prototype objects determined to match the target object.

In another aspect, determining the desired orientation of the target is based, at least in part, on a characteristic of the target object.

In another aspect, the characteristic of the target object includes information about contents of the target object.

In another aspect, the characteristic of the object includes a center of mass of the target object and/or a moment of inertia of the target object.

In another aspect, determining the desired orientation of the target object comprises determining the desired orientation as a same orientation as an orientation of the target object prior to the robotic device grasping the target object.

In another aspect, the at least one computing device is further configured to determine a stability estimate associated with placing a side of the target object on a surface, wherein determining the desired orientation of the target object is based, at least in part, on the stability estimate.

In another aspect, determining the stability estimate comprises calculating a ratio of dimensions of the side of the target object, and determining the stability estimate based, at least in part, on the ratio.

In another aspect, the at least one computing device is further configured to control the robotic arm to orient the target object based on the desired orientation.

Another aspect of the present disclosure provides a non-transitory computer readable medium encoded with a plurality of instructions that, when executed by at least one computing device, perform a method. The method comprises receiving information about a plurality of two-dimensional (2D) object faces of the objects in the environment, determining, based at least in part on the information, whether each of the plurality of 2D object faces matches a prototype object of a set of prototype objects stored in a memory accessible to the at least one computing device, wherein each of the prototype objects in the set represents a three-dimensional (3D) object, and generating a model of 3D objects in the environment using one or more of the prototype objects in the set of prototype objects that was determined to match one or more of the 2D object faces.

Another aspect of the present disclosure provides a method of determining a next object of a plurality of objects in an environment of a robotic device to grasp. The method comprises receiving, by at least one computing device, a model of three-dimensional (3D) objects in the environment of the robotic device, determining, by the at least one computing device, a set of pickable objects based, at least in part, on the model of 3D objects, selecting, by the at least one computing device, a target object from the set of pickable objects, and controlling, by the at least one computing device, the robotic device to grasp the target object.

In another aspect, the method further comprises determining interactions between an object in the model of 3D objects and another object in the environment of the robotic device, filtering the set of pickable objects based, at least in part, on the determined interactions, and selecting the target object from the filtered set of pickable objects.

In another aspect, determining interactions between an object in the model of 3D objects and another object in the environment of the robotic device comprises determining which objects in the model have extraction constraints dependent on extraction of one or more other objects in the model, and filtering the set of pickable objects comprises including in the filtered set of pickable objects, only objects in the model that do not have extraction constraints dependent on extraction of one or more other objects in the model.

In another aspect, an object in the model is determined to have an extraction constraint when another object in the model is located above the object.

In another aspect, the another object comprises an object not in the generated model of 3D objects.

In another aspect, the another object comprises one or more of a wall or a ceiling of an enclosure within which the robotic device is operating.

In another aspect, determining interactions between an object in the model of 3D objects and another object is based, at least in part on at least one potential extraction trajectory associated with the object in the model.

In another aspect, the method further comprises determining a reserved space through which the at least one potential extraction trajectory will travel, and including in the filtered set of pickable objects, only objects in the model that have a corresponding reserved space in which no other objects are present.

In another aspect, the reserved space is a space above and toward the robotic device.

Another aspect of the present disclosure provides a robotic device, comprising a robotic arm having disposed thereon, a suction-based gripper configured to grasp a target object, and at least one computing device. The at least one computing device is configured to receive a model of three-dimensional (3D) objects in the environment of the robotic device, determine a set of pickable objects based, at least in part, on the model of 3D objects, select the target object from the set of pickable objects, and control the robotic arm to grasp the target object.

In another aspect, the at least one computing device is further configured to determine a desired orientation of the target object, control the robotic arm to orient the target object based on the desired orientation, and place the target object in the desired orientation at a target location.

In another aspect, the target location includes a conveyor, and determining the desired orientation of the target object comprises determining to align a longest axis of the target object with a length dimension of the conveyor.

Another aspect of the present disclosure provides a non-transitory computer readable medium encoded with a plurality of instructions that, when executed by at least one computing device, perform a method. The method comprises receiving a model of three-dimensional (3D) objects in the environment of the robotic device, determining a set of pickable objects based, at least in part, on the model of 3D objects, selecting a target object from the set of pickable objects, and controlling the robotic device to grasp the target object.

In another aspect, the method further comprises determining a desired orientation of the target object, controlling the robotic arm to orient the target object based on the desired orientation, and placing the target object in the desired orientation at a target location.

In another aspect, the target location includes a conveyor, and determining the desired orientation of the target object comprises determining to align a longest axis of the target object with a length dimension of the conveyor.

Another aspect of the present disclosure provides a method of determining an unknown property of an object in a stack of objects in environment of a robotic device. The method comprises grasping the object from the stack of objects with a gripper of the robotic device, rotating the object such that a first face of the object including the unknown property is facing the robotic device, capturing an image of the first face of the object, and determining the unknown property of the object based on the captured image of the first face of the object.

In another aspect, the method further comprises prior to grasping the object, capturing an image of the stack of objects, wherein the captured image includes a second face of the object, determining first properties of the object based on the second face of the object included in the captured image of the stack of objects, and storing a prototype of a 3D object, wherein the prototype includes the first properties and the unknown property determined based on the captured image of the first face of the object.

In another aspect, the first properties of the object including a first dimension and a second dimension of the object, and wherein the unknown property includes a third dimension of the object.

In another aspect, the unknown property includes one or more of a dimension of the object, a texture of the object, or a color of the object.

In another aspect, the unknown property comprises an unknown dimension of the object, and determining the unknown dimension of the object based on the captured image of the first face of the object comprises identifying a first planar surface in the captured image, and calculating the unknown dimension of the object based on the first planar surface.

In another aspect, identifying a first planar surface in the captured image comprises using a region growing technique to identify the first planar surface.

In another aspect, calculating the unknown dimension of the object based on the first planar surface comprises fitting a rectangle to the first planar surface and calculating the unknown dimension of the object based on the fitted rectangle.

In another aspect, the method further comprises identifying a plurality of planar surfaces in the captured image, and identifying the first planar surface as a largest planar surface of the plurality of planar surfaces.

Another aspect of the present disclosure provides a robotic device, comprising a robotic arm having disposed thereon, a suction-based gripper configured to grasp a target object from a stack of objects, a perception system configured to capture one or more images, and at least one computing device. The at least one computing device is configured to control the robotic arm to rotate the object such that a first face of the object including the unknown property is facing the robotic device, control the perception system to capture an image of the first face of the object, and determine the unknown property of the object based on the captured image of the first face of the object.

Another aspect of the present disclosure provides a non-transitory computer readable medium encoded with a plurality of instructions that, when executed by at least one computing device, perform a method. The method comprises controlling a robotic arm to grasp an object from the stack of objects with a gripper of the robotic device, controlling the robotic arm to rotate the object such that a first face of the object including an unknown property is facing the robotic device, controlling a perception system to capture an image of the first face of the object, and determining the unknown property of the object based on the captured image of the first face of the object.

Another aspect of the present disclosure provides a method of placing an object with a desired orientation. The method comprises grasping an object with a suction-based gripper of a robotic device, the object being associated with at least one prototype describing at least one dimension of the object, determining a desired orientation of the object; orienting, by the robotic device, the object based on the desired orientation and the at least one prototype associated with the object; and controlling the robotic device to place the object in the desired orientation at a target location.

In another aspect, determining the desired orientation of the object is based, at least in part, on the target location.

In another aspect, the target location includes a conveyor, and determining the desired orientation of the object comprises determining to align a longest axis of the object with a length dimension of the conveyor.

In another aspect, the method further comprises determining the longest axis of the object based on at least one prototype associated with the object.

In another aspect, determining the desired orientation of the target is based, at least in part, on a characteristic of the object.

In another aspect, the characteristic of the target object includes information about contents of the object.

In another aspect, the characteristic of the object includes a center of mass of the object and/or a moment of inertia of the object.

In another aspect, determining the desired orientation of object comprises determining the desired orientation as a same orientation as an orientation of the object prior to the robotic device grasping the object with the suction-based gripper.

In another aspect, the method further comprises determining a stability estimate associated with placing a side of the object on a surface, wherein determining the desired orientation of the object is based, at least in part, on the stability estimate.

In another aspect, determining the stability estimate comprises calculating a ratio of dimensions of the side of the object, and determining the stability estimate based, at least in part, on the ratio.

Another aspect of the present disclosure provides a robotic device. The robotic device comprises a robotic arm having disposed thereon, a suction-based gripper configured to grasp an object, and at least one computing device. The at least one computing device is configured to control the robotic arm to grasp the object with the suction-based gripper, the object being associated with at least one prototype describing at least one dimension of the object, determine a desired orientation of the object, control the robotic arm to orient the object based on the desired orientation and the at least one prototype associated with the object, and control the robotic device to place the object in the desired orientation at a target location.

Another aspect of the present disclosure provides a non-transitory computer readable medium encoded with a plurality of instructions that, when executed by at least one computing device, perform a method. The method comprises controlling a robotic arm to grasp an object with a suction-based gripper of a robotic device, the object being associated with at least one prototype describing at least one dimension of the object, determining a desired orientation of the object, controlling the robotic arm to orient the object based on the desired orientation and the at least one prototype associated with the object, and controlling the robotic arm to place the object in the desired orientation at a target location.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a perspective view of one embodiment of a robot;

FIG. 1B is another perspective view of the robot of FIG. 1A;

FIG. 2A depicts robots performing tasks in a warehouse environment;

FIG. 2B depicts a robot unloading boxes from a truck;

FIG. 2C depicts a robot building a pallet in a warehouse aisle;

FIG. 3 is an illustrative computing architecture for a robotic device that may be used in accordance with some embodiments;

FIG. 4 is a flowchart of a process for detecting and grasping boxes by a robotic device in accordance with some embodiments;

FIG. 5A is a flowchart of a process for detecting boxes in an image captured by a perception module of a robotic device in accordance with some embodiments;

FIG. 5B is a flowchart of a process for generating a model of a three-dimensional (3D) stack of objects based on a two-dimensional (2D) image of object faces in accordance with some embodiments;

FIG. 6A is a schematic diagram of an ambiguous object detection scenario;

FIG. 6B is a schematic diagram of a technique for generating 3D object estimates based on stored prototypes of 3D objects and 2D object face detections in accordance with some embodiments;

FIG. 7 is a flowchart of a process for generating a model of 3D objects in a stack of objects in accordance with some embodiments;

FIG. 8A is a schematic representation of estimating the depth of objects in a stack of objects when no prototypes of 3D objects are known in accordance with some embodiments;

FIG. 8B is a schematic diagram of a technique for estimating the depth of objects in a stack of objects as depicted in FIG. 8A by imposing a façade constraint in accordance with some embodiments;

FIG. 8C is a schematic diagram of a technique for generating a prototype 3D object in accordance with some embodiments;

FIG. 8D is a schematic diagram of a technique for dynamically updating a set of prototypes of 3D objects used to generate a model of 3D objects in accordance with some embodiments;

FIG. 8E is a schematic diagram for further dynamically updating a set of prototypes of 3D objects shown in FIG. 8D, which is used to generate a model of 3D objects in accordance with some embodiments;

FIG. 8F is a schematic representation of a model of 3D objects generated in accordance with some embodiments;

FIG. 9 is a schematic diagram of a scenario in which a 2D object face matches multiple prototypes of 3D objects in a set of stored prototypes in accordance with some embodiments;

FIG. 10 is a flowchart of a process for determining a pick order for objects in a stack of objects based on a model of 3D objects in accordance with some embodiments;

FIG. 11 is a schematic diagram illustrating interactions between objects in an environment of a robotic device, which may be used to determine a pick order for the objects in accordance with some embodiments;

FIG. 12 is a flowchart of a process for generating a prototype of a 3D object for an object in a stack of objects that has an unknown dimension in accordance with some embodiments;

FIG. 13 is a schematic representation of a robotic device configured to rotate a grasped object to determine an unknown dimension of the grasped object;

FIG. 14 is a flowchart of a process for determining an unknown dimension of a grasped object based on an image of a face of the grasped object that includes the unknown dimension;

FIG. 15 is a flowchart of a process for placing an object grasped by a robotic device in a desired orientation, in accordance with some embodiments;

FIG. 16 is a flowchart of a process for placing an object grasped by a robotic device in a desired orientation on a conveyor, in accordance with some embodiments.

FIGS. 17A-17D illustrate a first example sequence of simulation screenshots of a process for picking and placing an object on a conveyor, in accordance with some embodiments.

FIGS. 18A-18C illustrate a second example sequence of simulation screenshots of a process for picking and placing an object on a conveyor, in accordance with some embodiments.

FIGS. 19A-19C illustrate a third example sequence of simulation screenshots of a process for picking and placing an object on a conveyor, in accordance with some embodiments.

### DETAILED DESCRIPTION

Robots are typically configured to perform various tasks in an environment in which they are placed. Generally, these tasks include interacting with objects and/or the elements of the environment. Notably, robots are becoming popular in warehouse and logistics operations. Before the introduction of robots to such spaces, many operations were performed manually. For example, a person might manually unload boxes from a truck onto one end of a conveyor belt, and a second person at the opposite end of the conveyor belt might organize those boxes onto a pallet. The pallet may then be picked up by a forklift operated by a third person, who might drive to a storage area of the warehouse and drop the pallet for a fourth person to remove the individual boxes from the pallet and place them on shelves in the storage area. More recently, robotic solutions have been developed to automate many of these functions. Such robots may either be specialist robots (i.e., designed to perform a single task, or a small number of closely related tasks) or generalist robots (i.e., designed to perform a wide variety of tasks). To date, both specialist and generalist warehouse robots have been associated with significant limitations, as explained below.

A specialist robot may be designed to perform a single task, such as unloading boxes from a truck onto a conveyor belt. While such specialist robots may be efficient at performing their designated task, they may be unable to perform other, tangentially related tasks in any capacity. As such, either a person or a separate robot (e.g., another specialist robot designed for a different task) may be needed to perform the next task(s) in the sequence. As such, a warehouse may need to invest in multiple specialist robots to perform a sequence of tasks, or may need to rely on a hybrid operation in which there are frequent robot-to-human or human-to-robot handoffs of objects.

In contrast, a generalist robot may be designed to perform a wide variety of tasks, and may be able to take a box through a large portion of the box's life cycle from the truck to the shelf (e.g., unloading, palletizing, transporting, depalletizing, storing). While such generalist robots may perform a variety of tasks, they may be unable to perform individual tasks with high enough efficiency or accuracy to warrant introduction into a highly streamlined warehouse operation. For example, while mounting an off-the-shelf robotic manipulator onto an off-the-shelf mobile robot might yield a system that could, in theory, accomplish many warehouse tasks, such a loosely integrated system may be incapable of performing complex or dynamic motions that require coordination between the manipulator and the mobile base, resulting in a combined system that is inefficient and inflexible. Typical operation of such a system within a warehouse environment may include the mobile base and the manipulator operating sequentially and (partially or entirely) independently of each other. For example, the mobile base may first drive toward a stack of boxes with the manipulator powered down. Upon reaching the stack of boxes, the mobile base may come to a stop, and the manipulator may power up and begin manipulating the boxes as the base remains stationary. After the manipulation task is completed, the manipulator may again power down, and the mobile base may drive to another destination to perform the next task. As should be appreciated from the foregoing, the mobile base and the manipulator in such systems are effectively two separate robots that have been joined together; accordingly, a controller associated with the manipulator may not be configured to share information with, pass commands to, or receive commands from a separate controller associated with the mobile base. As such, such a poorly integrated mobile manipulator robot may be forced to operate both its manipulator and its base at suboptimal speeds or through suboptimal trajectories, as the two separate controllers struggle to work together. Additionally, while there are limitations that arise from a purely engineering perspective, there are additional limitations that must be imposed to comply with safety regulations. For instance, if a safety regulation requires that a mobile manipulator must be able to be completely shut down within a certain period of time when a human enters a region within a certain distance of the robot, a loosely integrated mobile manipulator robot may not be able to act sufficiently quickly to ensure that both the manipulator and the mobile base (individually and in aggregate) do not a pose a threat to the human. To ensure that such loosely integrated systems operate within required safety constraints, such systems are forced to operate at even slower speeds or to execute even more conservative trajectories than those limited speeds and trajectories as already imposed by the engineering problem. As such, the speed and efficiency of generalist robots performing tasks in warehouse environments to date have been limited.

In view of the above, the inventors have recognized and appreciated that a highly integrated mobile manipulator robot with system-level mechanical design and holistic control strategies between the manipulator and the mobile base may be associated with certain benefits in warehouse and/or logistics operations. Such an integrated mobile manipulator robot may be able to perform complex and/or dynamic motions that are unable to be achieved by conventional, loosely integrated mobile manipulator systems. As a result, this type of robot may be well suited to perform a variety of different tasks (e.g., within a warehouse environment) with speed, agility, and efficiency.

### Example Robot Overview

In this section, an overview of some components of one embodiment of a highly integrated mobile manipulator robot configured to perform a variety of tasks is provided to explain the interactions and interdependencies of various subsystems of the robot. Each of the various subsystems, as well as control strategies for operating the subsystems, are described in further detail in the following sections.

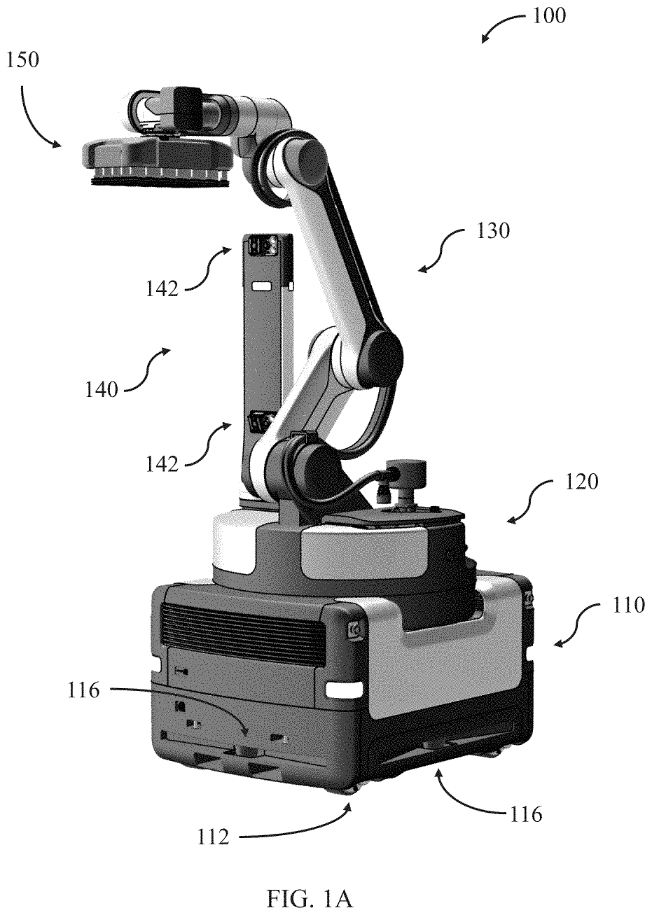

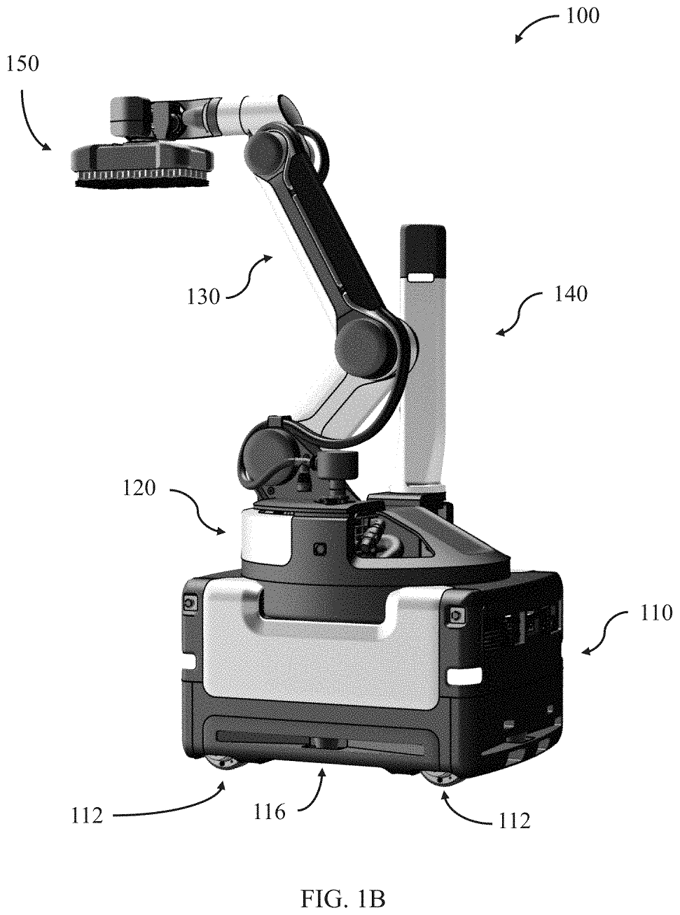

FIGS. 1A and 1B are perspective views of one embodiment of a robot 100. The robot 100 includes a mobile base 110 and a robotic arm 130. The mobile base 110 includes an omnidirectional drive system that enables the mobile base to translate in any direction within a horizontal plane as well as rotate about a vertical axis perpendicular to the plane. Each wheel 112 of the mobile base 110 is independently steerable and independently drivable. The mobile base 110 additionally includes a number of distance sensors 116 that assist the robot 100 in safely moving about its environment. The robotic arm 130 is a 6 degree of freedom (6-DOF) robotic arm including three pitch joints and a 3-DOF wrist. An end effector 150 is disposed at the distal end of the robotic arm 130. The robotic arm 130 is operatively coupled to the mobile base 110 via a turntable 120, which is configured to rotate relative to the mobile base 110. In addition to the robotic arm 130, a perception mast 140 is also coupled to the turntable 120, such that rotation of the turntable 120 relative to the mobile base 110 rotates both the robotic arm 130 and the perception mast 140. The robotic arm 130 is kinematically constrained to avoid collision with the perception mast 140. The perception mast 140 is additionally configured to rotate relative to the turntable 120, and includes a number of perception modules 142 configured to gather information about one or more objects in the robot's environment. The integrated structure and system-level design of the robot 100 enable fast and efficient operation in a number of different applications, some of which are provided below as examples.

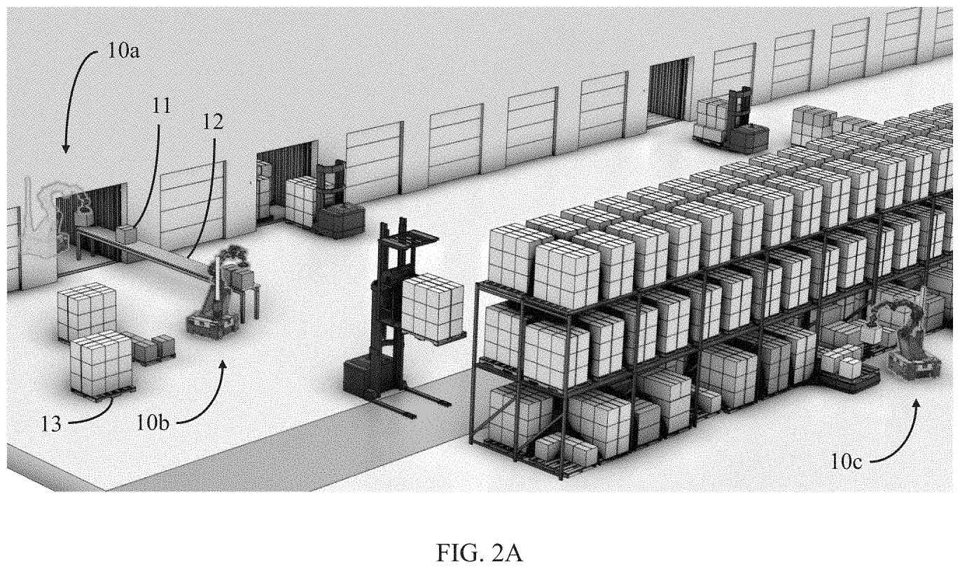

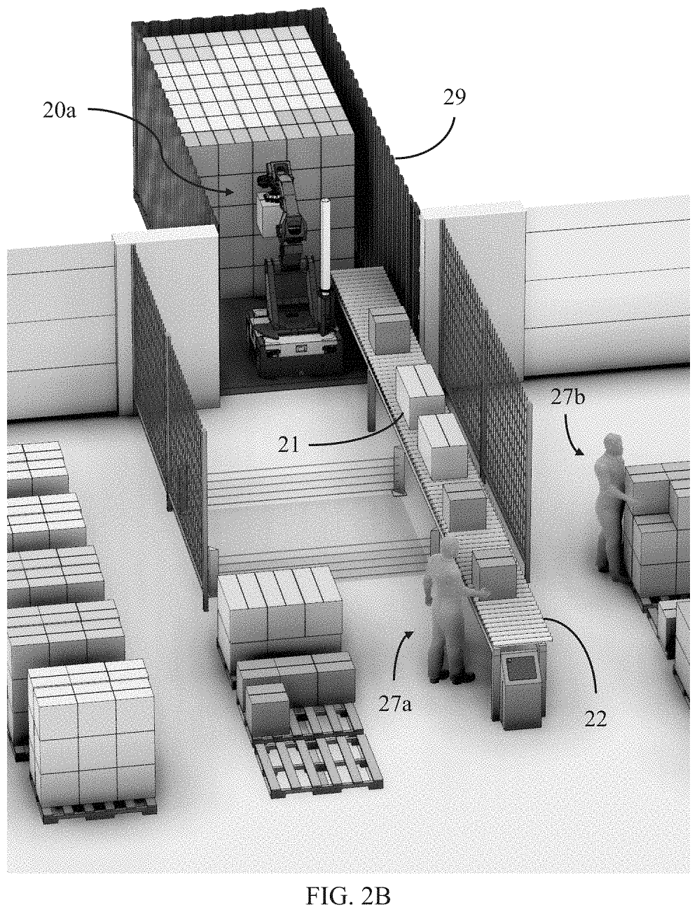

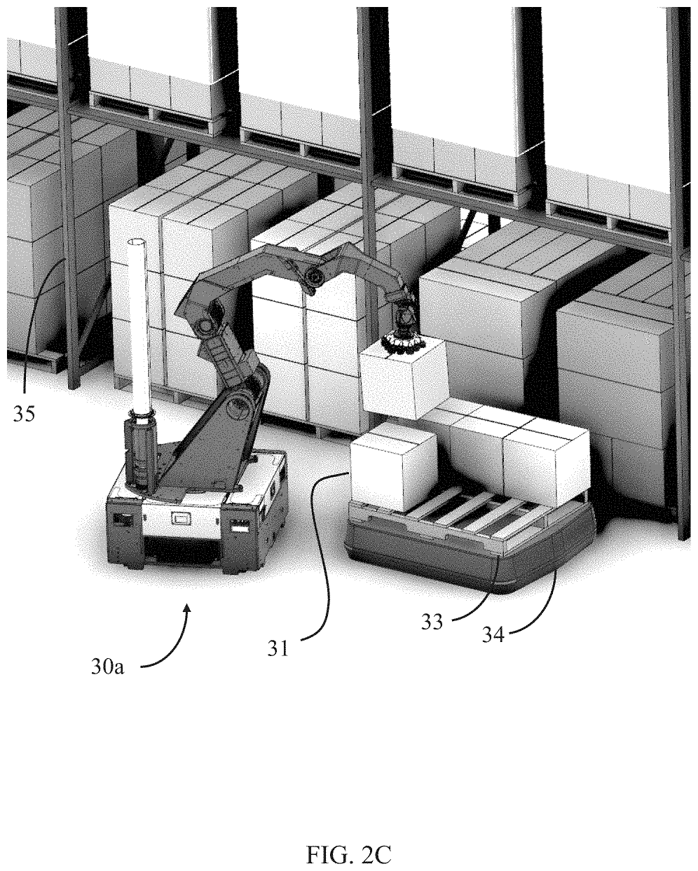

FIG. 2A depicts robots 10a, 10b, and 10c performing different tasks within a warehouse environment. A first robot 10a is inside a truck (or a container), moving boxes 11 from a stack within the truck onto a conveyor belt 12 (this particular task will be discussed in greater detail below in reference to FIG. 2B). At the opposite end of the conveyor belt 12, a second robot 10b organizes the boxes 11 onto a pallet 13. In a separate area of the warehouse, a third robot 10c picks boxes from shelving to build an order on a pallet (this particular task will be discussed in greater detail below in reference to FIG. 2C). It should be appreciated that the robots 10a, 10b, and 10c are different instances of the same robot (or of highly similar robots). Accordingly, the robots described herein may be understood as specialized multi-purpose robots, in that they are designed to perform specific tasks accurately and efficiently, but are not limited to only one or a small number of specific tasks.

FIG. 2B depicts a robot 20a unloading boxes 21 from a truck 29 and placing them on a conveyor belt 22. In this box picking application (as well as in other box picking applications), the robot 20a will repetitiously pick a box, rotate, place the box, and rotate back to pick the next box. Although robot 20a of FIG. 2B is a different embodiment from robot 100 of FIGS. 1A and 1B, referring to the components of robot 100 identified in FIGS. 1A and 1B will ease explanation of the operation of the robot 20a in FIG. 2B. During operation, the perception mast of robot 20a (analogous to the perception mast 140 of robot 100 of FIGS. 1A and 1B) may be configured to rotate independent of rotation of the turntable (analogous to the turntable 120) on which it is mounted to enable the perception modules (akin to perception modules 142) mounted on the perception mast to capture images of the environment that enable the robot 20a to plan its next movement while simultaneously executing a current movement. For example, while the robot 20a is picking a first box from the stack of boxes in the truck 29, the perception modules on the perception mast may point at and gather information about the location where the first box is to be placed (e.g., the conveyor belt 22). Then, after the turntable rotates and while the robot 20a is placing the first box on the conveyor belt, the perception mast may rotate (relative to the turntable) such that the perception modules on the perception mast point at the stack of boxes and gather information about the stack of boxes, which is used to determine the second box to be picked. As the turntable rotates back to allow the robot to pick the second box, the perception mast may gather updated information about the area surrounding the conveyor belt. In this way, the robot 20a may parallelize tasks which may otherwise have been performed sequentially, thus enabling faster and more efficient operation.

Also of note in FIG. 2B is that the robot 20a is working alongside humans (e.g., workers 27a and 27b). Given that the robot 20a is configured to perform many tasks that have traditionally been performed by humans, the robot 20a is designed to have a small footprint, both to enable access to areas designed to be accessed by humans, and to minimize the size of a safety zone around the robot into which humans are prevented from entering.

FIG. 2C depicts a robot 30a performing an order building task, in which the robot 30a places boxes 31 onto a pallet 33. In FIG. 2C, the pallet 33 is disposed on top of an autonomous mobile robot (AMR) 34, but it should be appreciated that the capabilities of the robot 30a described in this example apply to building pallets not associated with an AMR. In this task, the robot 30a picks boxes 31 disposed above, below, or within shelving 35 of the warehouse and places the boxes on the pallet 33. Certain box positions and orientations relative to the shelving may suggest different box picking strategies. For example, a box located on a low shelf may simply be picked by the robot by grasping a top surface of the box with the end effector of the robotic arm (thereby executing a “top pick”). However, if the box to be picked is on top of a stack of boxes, and there is limited clearance between the top of the box and the bottom of a horizontal divider of the shelving, the robot may opt to pick the box by grasping a side surface (thereby executing a “face pick”).

To pick some boxes within a constrained environment, the robot may need to carefully adjust the orientation of its arm to avoid contacting other boxes or the surrounding shelving. For example, in a typical “keyhole problem”, the robot may only be able to access a target box by navigating its arm through a small space or confined area (akin to a keyhole) defined by other boxes or the surrounding shelving. In such scenarios, coordination between the mobile base and the arm of the robot may be beneficial. For instance, being able to translate the base in any direction allows the robot to position itself as close as possible to the shelving, effectively extending the length of its arm (compared to conventional robots without omnidirectional drive which may be unable to navigate arbitrarily close to the shelving). Additionally, being able to translate the base backwards allows the robot to withdraw its arm from the shelving after picking the box without having to adjust joint angles (or minimizing the degree to which joint angles are adjusted), thereby enabling a simple solution to many keyhole problems.

Of course, it should be appreciated that the tasks depicted in FIGS. 2A-2C are but a few examples of applications in which an integrated mobile manipulator robot may be used, and the present disclosure is not limited to robots configured to perform only these specific tasks. For example, the robots described herein may be suited to perform tasks including, but not limited to, removing objects from a truck or container, placing objects on a conveyor belt, removing objects from a conveyor belt, organizing objects into a stack, organizing objects on a pallet, placing objects on a shelf, organizing objects on a shelf, removing objects from a shelf, picking objects from the top (e.g., performing a “top pick”), picking objects from a side (e.g., performing a “face pick”), coordinating with other mobile manipulator robots, coordinating with other warehouse robots (e.g., coordinating with AMRs), coordinating with humans, and many other tasks.

### Example Computing Device

Control of one or more of the robotic arm, the mobile base, the turntable, and the perception mast may be accomplished using one or more computing devices located on-board the mobile manipulator robot. For instance, one or more computing devices may be located within a portion of the mobile base with connections extending between the one or more computing devices and components of the robot that provide sensing capabilities and components of the robot to be controlled. In some embodiments, the one or more computing devices may be coupled to dedicated hardware configured to send control signals to particular components of the robot to effectuate operation of the various robot systems. In some embodiments, the mobile manipulator robot may include a dedicated safety-rated computing device configured to integrate with safety systems that ensure safe operation of the robot.

The computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the terms “physical processor” or “computer processor” generally refer to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

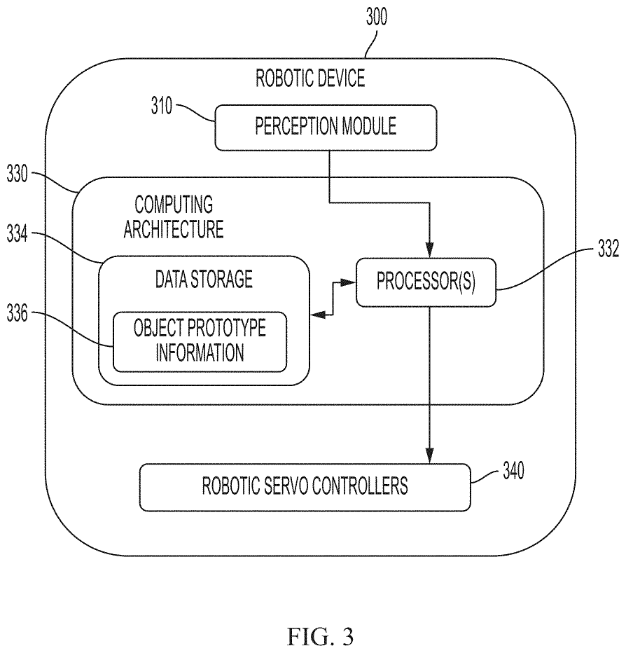

FIG. 3 illustrates an example computing architecture 310 for a robotic device 300, according to an illustrative embodiment of the invention. The computing architecture 310 includes one or more processors 332 and data storage 334 in communication with processor(s) 332. Robotic device 300 may also include a perception module 310 (which may include, e.g., the perception mast 140 shown and described above in FIGS. 1A-1B). The perception module 310 may be configured to provide input to processor(s) 332. For instance, perception module 310 may be configured to provide one or more images to processor(s) 332, which may be programmed to detect one or more objects in the provided one or more images for grasping by the robotic device. Data storage 334 may be configured to store object prototype information 336 for a set of object prototypes. The object prototype information may be used by processor(s) 332 to represent information (e.g., dimensions, textures, colors) for known objects in a stack from which the robotic device is picking. In some embodiments, the initial set of object prototypes may initially include no prototypes. In other embodiments, the initial set of object prototypes may include one or more prototypes specified by a user (e.g., via a user interface) or another computing device (e.g., a warehouse management system) to reflect the types of objects the robot is expected to perceive. The initial set of object prototypes may be augmented with additional prototypes as information about objects in a stack of objects is learned during picking, as discussed in more detail below. Robotic device 300 may also include robotic servo controllers 340, which may be in communication with processor(s) 332 and may receive control commands from processor(s) 332 to move a corresponding portion of the robotic device. For example, after an object has been identified as the next object to pick from the stack, the processor(s) 332 may issue control instructions to robotic servo controllers 340 to control operation of an arm and/or gripper of the robotic device to grasp the object.

During operation, perception module 310 can perceive one or more objects (e.g., boxes) for grasping (e.g., by an end-effector of the robotic device 300) and/or one or more aspects of the robotic device's environment. In some embodiments, perception module 310 includes one or more sensors configured to sense the environment. For example, the one or more sensors may include, but are not limited to, a color camera, a depth camera, a LIDAR or stereo vision device, or another device with suitable sensory capabilities. In some embodiments, image(s) captured by perception module 310 are processed by processor(s) 332 using trained object detection model(s) to extract surfaces (e.g., faces) of boxes or other objects in the image capable of being grasped by the robotic device 300.

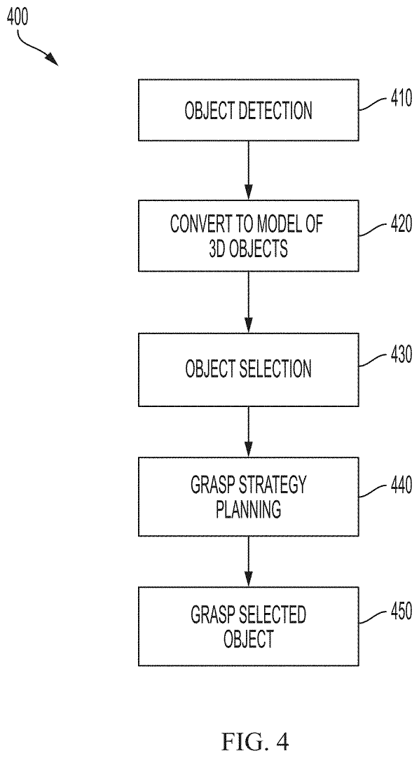

FIG. 4 illustrates a process 400 for grasping an object (e.g., a parcel such as a box) using an end-effector of a robotic device in accordance with some embodiments. In act 410, objects of interest to be grasped by the robotic device are detected in one or more images (e.g., RGBD images) captured by a perception module of the robotic device. For instance, the one or more images may be analyzed using one or more trained object detection models to detect one or more object faces in the image(s). Following object detection, process 400 proceeds to act 420, where two-dimensional (2D) object faces are converted into three-dimensional (3D) objects based on a set of prototypes, as discussed in more detail below. Process 400 then proceeds to act 430, where a particular “target” object of the set of modeled 3D objects is selected (e.g., to be grasped next by the robotic device). In some embodiments, a set of “pickable” objects capable of being grasped by the robotic device (which may include all or a subset of objects in the environment near the robot) may be determined as candidate objects for grasping. Then, one of the candidate objects may be selected as the target object for grasping. As described in more detail below, the candidate objects for grasping may be continually updated during the picking process to be able to select a next box for picking that reduces the possibility of causing the stack to fall over or damage objects in the stack, among other things. Process 400 then proceeds to act 440, where grasp strategy planning for the robotic device is performed. The grasp strategy planning may, for example, select from among multiple grasp candidates, each of which describes a manner in which to grasp the target object. Grasp strategy planning may include, but is not limited to, the placement of a gripper of the robotic device on (or near) a surface of the selected object and one or more movements of the robotic device (a grasp trajectory) necessary to achieve such gripper placement on or near the selected object. Process 400 then proceeds to act 450, where the target object is grasped by the robotic device according to the grasp strategy planning determined in act 440.

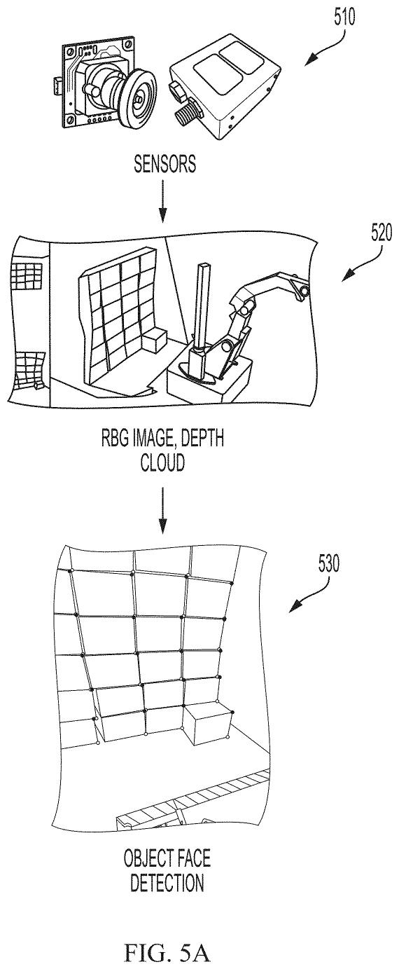

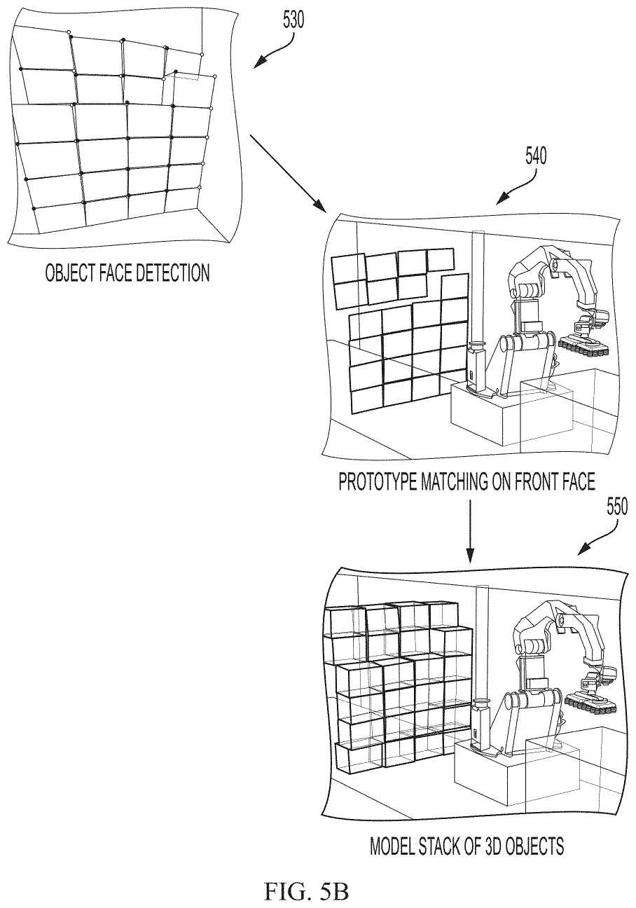

FIG. 5A schematically illustrates a process for detecting objects in an environment of a robotic device in accordance with some embodiments. As described in connection with FIGS. 1A and 1B, a mobile manipulator robot may include one or more sensors configured to capture information about the environment of the robot. The sensor(s) 510 of the robot may include one or more perception modules that include a color camera (e.g., a red-green-blue (RGB) monocular camera) and a depth sensor (e.g., a time-of-flight (TOF) depth sensor) to determine one or more characteristics of objects (e.g., boxes) in the environment. For instance, an RGB image captured by the color camera and depth information captured by the depth sensor may be combined to generate an RGBD image. The RGBD image may be conceptualized as a high-fidelity colorized 3D point cloud, which includes both color appearance as well as depth data and 3D geometric structure of objects in the environment (shown in FIG. 5 as “RGB Image, Depth Cloud”). In some embodiments, the RGB image and the depth information are combined by registering the RGB image and the depth information to create the RGBD image. As part of the registration process, distortion in one or both of the color image and the depth information caused, for example, by motion of the mobile robot or objects in the environment, may be corrected. Several other factors may additionally or alternatively be taken into account to properly register the RGB image and the depth information. For example, these factors include the intrinsic properties of the cameras (e.g., focal lengths, principal points of the cameras) and the extrinsic properties of the cameras (e.g., the precise position and orientations of the RGB camera and the TOF depth sensor camera with respect to each other). A calibration sequence executed for each set of sensors in a perception module may be performed to determine these intrinsic and extrinsic properties for use in registering the RGB image and the depth information to generate an RGBD image.

Information about objects in the environment of the robotic device may be determined based on the RGBD image. In some embodiments, the RGBD image is provided as input to a trained statistical model (e.g., a machine learning model) that has been trained to identify one or more characteristics of objects of interest. For instance, the statistical model may be trained to recognize surfaces (e.g., faces) of objects 530 arranged in a stack as shown in FIG. 5. Any suitable type of trained statistical model may be used to process an RGBD image and output one or more characteristics of object(s) in the environment. In some embodiments, the trained statistical model is implemented as a neural network (e.g., a deep neural network) that includes a plurality of nodes arranged in layers and weights connecting the nodes between the layers. In some embodiments, the neural network is a convolutional neural network, a recurrent neural network, or a combination of types of neural networks.

The inventors have recognized and appreciated that to enable a robot to successfully pick objects from a stack without colliding with other objects in the stack, information about the full dimensions (e.g., height, width, depth) of the object to be grasped can be helpful (whether known, inferred, or estimated). For example, three-dimensional knowledge about an object may be helpful to place the gripper of the robot above the middle of the center of mass of the object and/or may be helpful to decide the order in which objects should be picked from the stack. In many cases, only two dimensions (e.g., height and width) of an object corresponding to the object front face are visible from the robot's perspective, with the depth dimension unknown. Knowing only two dimensions of the object may result in collisions between neighboring objects and collisions with other obstacles (e.g., truck walls, ceilings, racks, etc.) in the environment of the robot if the objects are not picked in an order that reduces the chance of such collisions.

FIG. 5B schematically illustrates a process for generating a model of a stack of three-dimensional objects based on object face detection as described in connection with FIG. 5A. In act 530, two-dimensional faces of objects in the stack are determined based, at least in part, on one or more images captured by a perception system of a robotic device, as also described in connection with FIG. 5A. In act 540, information about each of the detected object faces in the stack is matched to a set of stored prototypes to identify a three-dimensional model for the object that corresponds to the two-dimensional object face. Each prototype in the set of stored prototypes may include one or more features associated with a corresponding 3D model for the object that may be used to match to 2D object surfaces detected in one or more captured images. For instance, a stored prototype may include dimension (e.g., one or more of width, height, depth) information for the 3D object. Other features that may be associated with a stored prototype include, but are not limited to, texture information, color information, and identifier (e.g., barcode) information. In some embodiments, at least some of the features (e.g., texture information, color information) may be associated with a particular face of the object (e.g., front face, side face), such that a prototype may include information for multiple faces of the object to further distinguish the prototype from other prototypes in the set. As discussed in more detail below, prototypes may continue to be added to the set of prototypes during picking of objects from the stack when, for example, a detected object face does not match any of the prototypes in the current set. In act 550, a model of a stack of three-dimensional objects is generated by associating (to the extent possible) each of the detected object faces with one of the prototypes in the set of prototypes.

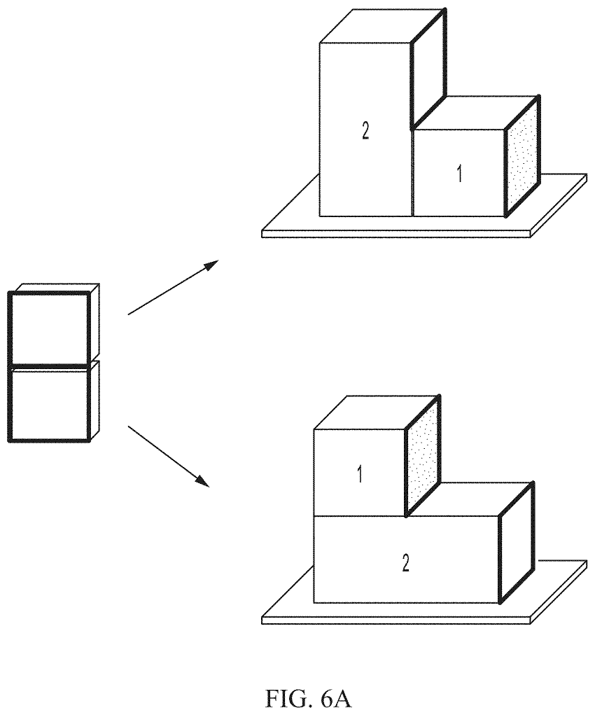

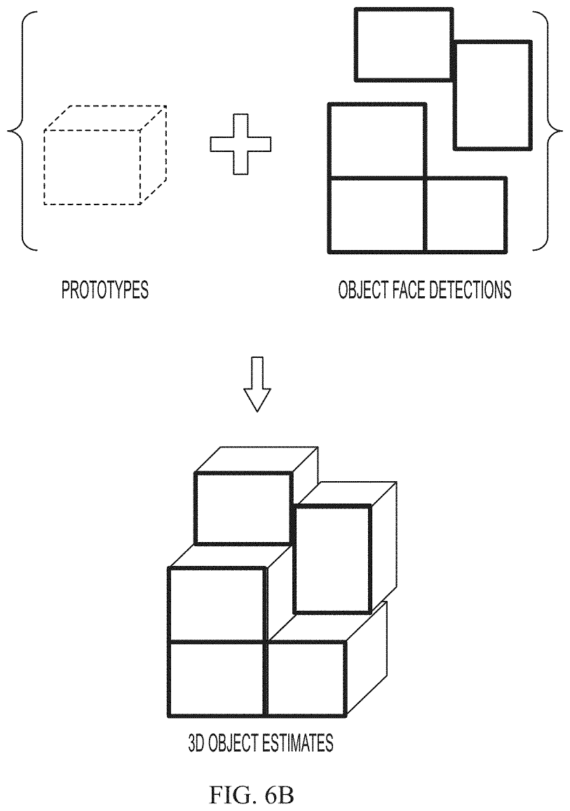

FIG. 6A schematically illustrates a scenario in which the same two-dimensional representation of a stack of two objects as perceived by a perception system of a robotic device may correspond to different actual object configurations. As shown, in the upper configuration, a shorter object is located in front of a taller object, whereas in the lower configuration, a shallower object is located on top of a deeper object. In the upper configuration, to prevent collisions between the objects, the shorter front object should be extracted first followed by the taller object behind it. In the lower configuration, the opposite is case. Namely, the farther shallower object on the top of the stack should be extracted prior to extracting the deeper object on the bottom of the stack. Although a simplistic example, FIG. 6A illustrates why knowing all dimensions of an object in a stack can be important to determine a preferred or optimal extraction order. Some embodiments are directed to techniques for associating each of the detected two-dimensional object faces with a model of a three-dimensional object to facilitate object picking and pick order determinations.

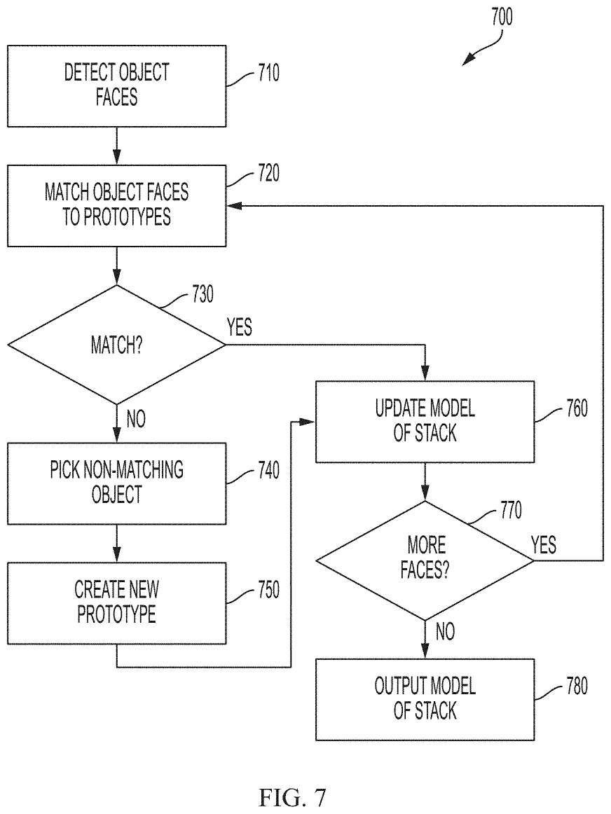

FIG. 6B schematically illustrates a process for modeling a stack of objects as a plurality of three-dimensional objects in accordance with some embodiments. A set of prototypes describing characteristics (e.g., dimensions, colors, textures) of known objects is stored by a robotic device. An initial set of prototypes may be an empty set (i.e., having no prototypes) or the set may be pre-seeded with one or more prototypes specified by a user or another computing device (e.g., a warehouse management system). For instance, the user or another computing device may have knowledge about the types of objects that the robot is likely to encounter and may include in the initial set, prototypes that align with that knowledge. Detected object faces are matched to prototypes in the set of prototypes to produce three-dimensional object estimates of the objects in the stack of objects. In some embodiments, a single detected object face may be matched to multiple prototypes in the set of prototypes. For instance, the dimensions of a detected object face may match (within a certain tolerance) multiple prototypes that have a similar face dimensions but different depth dimensions. Further details regarding the generation of a model of a stack of three-dimensional objects using a dynamically updated set of prototypes is described below in connection with FIG. 7.

FIG. 7 illustrates a flowchart of a process 700 for associating each of a plurality of two-dimensional object faces detected, for example, with a perception system of a robotic device, with one or more prototypes in a set of prototypes stored by the robotic device to produce a model of three-dimensional objects (e.g., as shown in FIG. 6B). In act 710, one or more faces of objects in an environment are detected using, for example, a perception system of a robotic device. Process 700 then proceeds to act 720, where each of the detected object faces is matched to one or more of a plurality of prototype objects in a stored set of prototypes. When more than one prototype object matches to a detected object face, a most likely prototype (e.g., determined based on information about other objects in the stack) may be selected for use in the model of three-dimensional objects. In some embodiments, one or more of the multiple matching prototype objects not determined to be the most likely prototype may be used for other purposes. For instance, one or more of the other matching prototypes may be used to reason about how to safely manipulate the object once grasped. If it is determined in act 730 that there is not a match between the object face and one of the prototypes in the set of prototypes (or if the set of prototypes does not include any prototypes), process 700 proceeds to act 740, where the non-matching object is picked from the stack. Process 700 then proceeds to act 750, where a new prototype for the non-matching object is created. For instance, as described in more detail below, the picked object may be manipulated to determine all dimensions (e.g., height, width, depth) of the object and the full dimensions of the object may be used to create a new prototype in act 750. The newly-created prototype may then be added to the set of prototypes. Process 700 then proceeds to act 760 where a model of three-dimensional objects forming the stack (e.g., as shown in FIG. 5B) is updated based on the association of the two-dimensional object face with the newly-created prototype. Process 700 then proceeds to act 770, where it is determined whether all of the detected object faces have been associated with prototypes. If it is determined that there are more object faces to match to prototypes, process 700 returns to act 720, where an unmatched object face is selected and a match to one or more of the prototypes in the set of prototypes is attempted. If it is determined in act 770 that there are no more object faces to match to prototypes, process 700 proceeds to act 780, where the model of three-dimensional objects of the stack is output. For example, the model of the stack may be provided as input to a process for determining interactions between objects in the stack, thereby enabling an informed selection of which object to pick next from the stack.

Although act 740 is shown in process 700 as being performed immediately after determining that an object face did not match any stored prototype in act 730, it should be appreciated that the non-matching object may be picked at some later time. For instance, all detected object faces may be attempted to be matched with stored prototypes and a three-dimensional model of the stack may be generated in act 760 only with the prototypes that matched those matched object faces. Then, when a next object is selected to be picked from the stack, if the selected object was determined not to match a prototype, that object can be picked from the stack, and a new prototype can be created at that point in time. In this way, a set of prototypes can be dynamically updated during an object picking process with limited interruption of the normal picking operation of the robotic device.

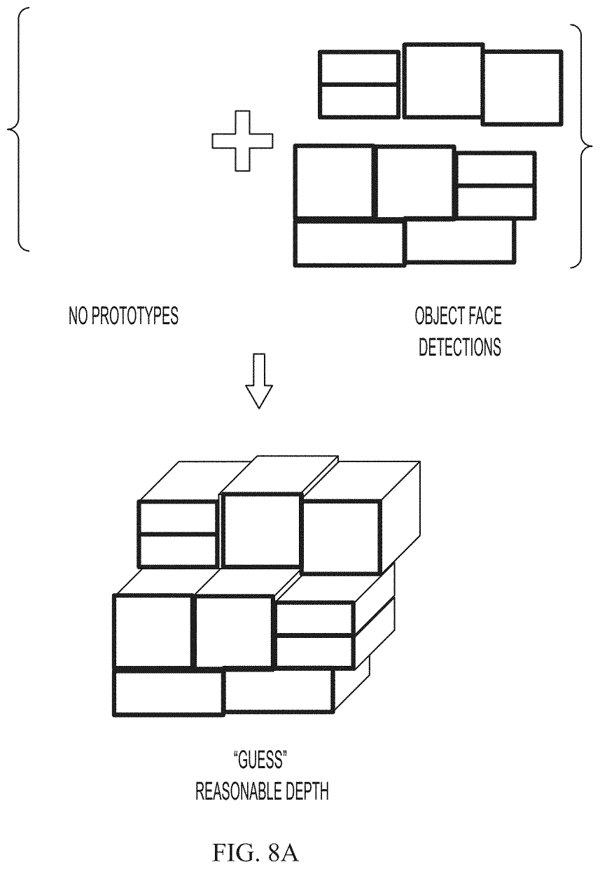

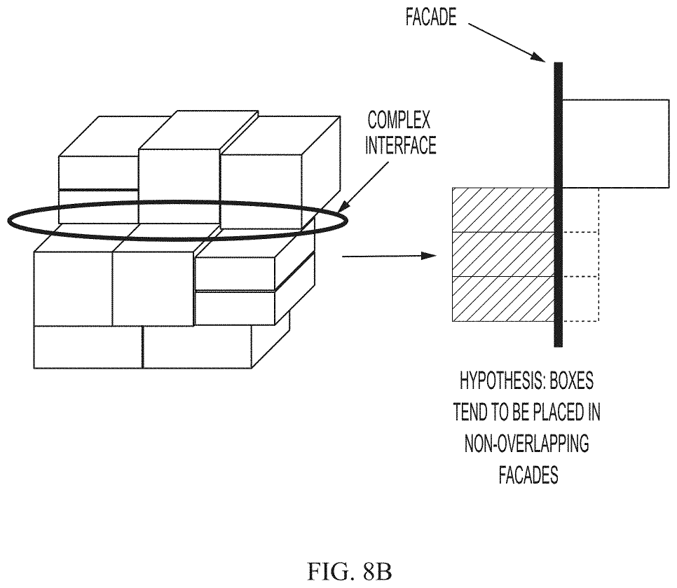

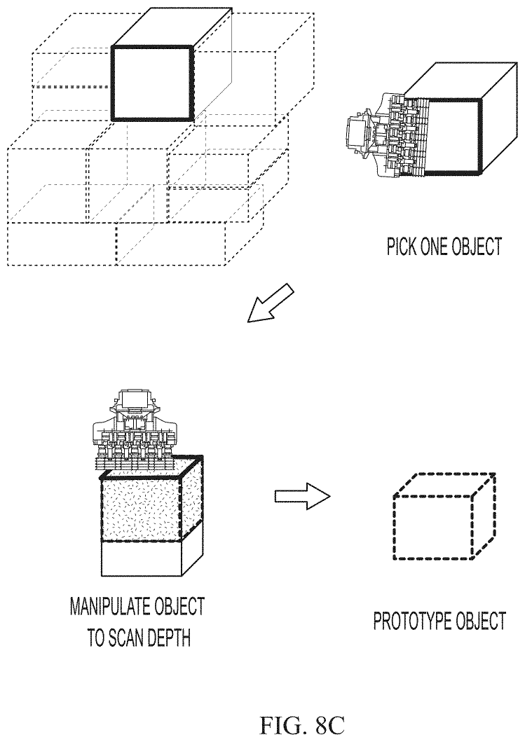

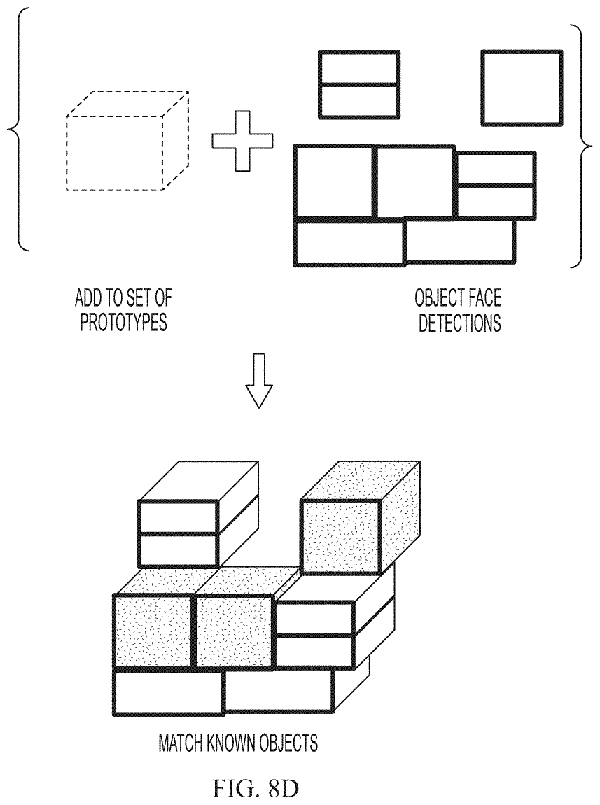

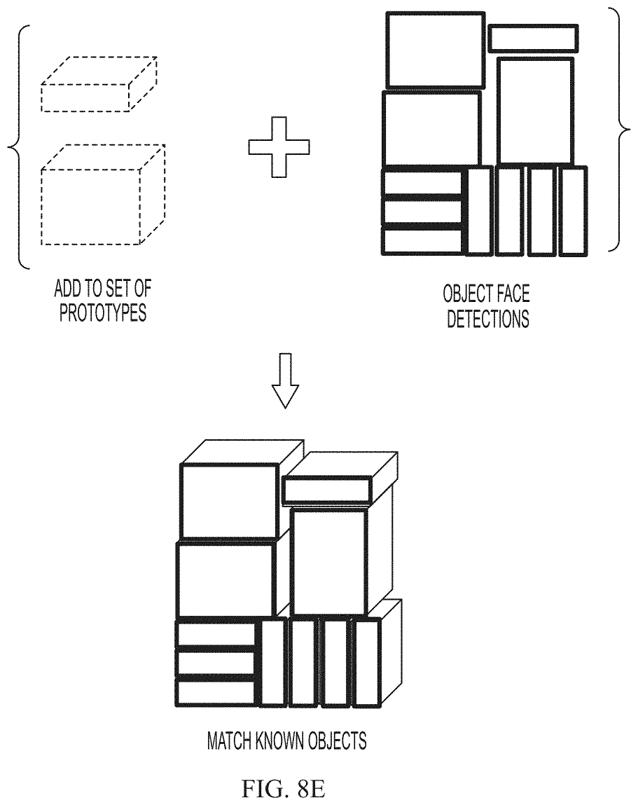

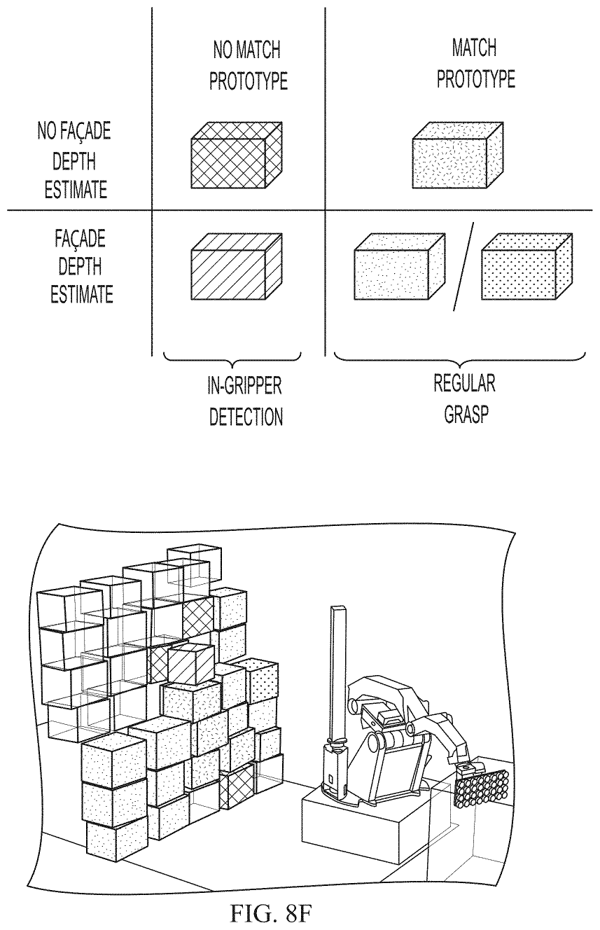

As described above, in some embodiments the set of prototypes stored by the robotic device may initially not include any prototypes, as shown in FIG. 8A. In such a situation, a reasonable assumption for the depth of the objects may be made to extract objects from the stack while reducing the chance that the extraction will result in collisions with other objects in the stack or obstructions in the environment. For example, the depth of the object may be assumed to be a fixed size or may be determined in any other suitable way (e.g., based on dimensions of one or more of the observable faces of the object). If not enough information is available from the captured image(s) of the stack to make a reasonable guess about the depth of objects in the stack, a complex interface where boxes are stacked in a partial overlapping manner as shown in FIG. 8B may be simplified such that the objects may be assumed to be placed in “facades” where there are virtual vertical planes separating the objects. Assuming that the objects are arranged in facades, a first object (e.g., an object in a façade closest to the robotic device and located at the top of the stack) can then be picked from the stack to create a prototype as discussed above in connection with process 700 of FIG. 7.

FIG. 8C schematically illustrates a process for creating a new prototype by picking an object from the stack and manipulating the object to determine the depth of the object. Other characteristics of the grasped object including, but not limited to, the color and/or texture of the object may also be associated with the prototype for the object. A further discussion of a technique for determining the depth dimension (and/or other unknown properties) of a picked object in accordance with some embodiments (also referred to herein as “in-gripper detection”) is described in more detail below.

FIG. 8D schematically illustrates that the newly-created prototype is added to the set of prototypes stored by the robotic device. The dynamically updated set of prototypes may then be used to match detected object faces (e.g., front faces, side faces or both) with one of the prototypes in the set as described above in connection with process 700 of FIG. 7. FIG. 8E schematically illustrates that as more prototypes are added to the set of prototypes, additional object faces may be matched until most or all of the objects in the stack are associated with one or more prototype, resulting in a three-dimensional model of the stack of objects based on the matched prototypes as shown in FIG. 8F. In some embodiments, prototypes that are not matched to an object face after a predetermined amount of time (e.g., one day, one week) may be removed from the set of prototypes to reduce the total number of prototypes in the set. Additionally, prototypes associated with a dropped object may also be removed from the set of prototypes.

The three-dimensional model of the stack of objects may be used to categorize the objects in the stack, which is used to inform the process of selecting a next object to pick from the stack. For instance, the three-dimensional model of the stack of objects may be used to evaluate interactions between neighboring objects in the stack to make an assessment of which objects should be grasped next and when they are grasped, whether they should be subjected to in-gripper detection to generate a new prototype in the set of prototypes. As shown in FIG. 8F, the objects in the three-dimensional model of the stack may be separated into at least four categories, which can be used to prioritize objects for picking. For instance, objects that match a prototype and have a façade depth estimate may be considered as better targets to pick compared with objects that do not match a prototype and have no façade depth estimate, as objects that both matched a prototype and have a façade depth estimate have a lower likelihood of failed extraction from the stack compared to non-matching objects with no façade depth estimate.

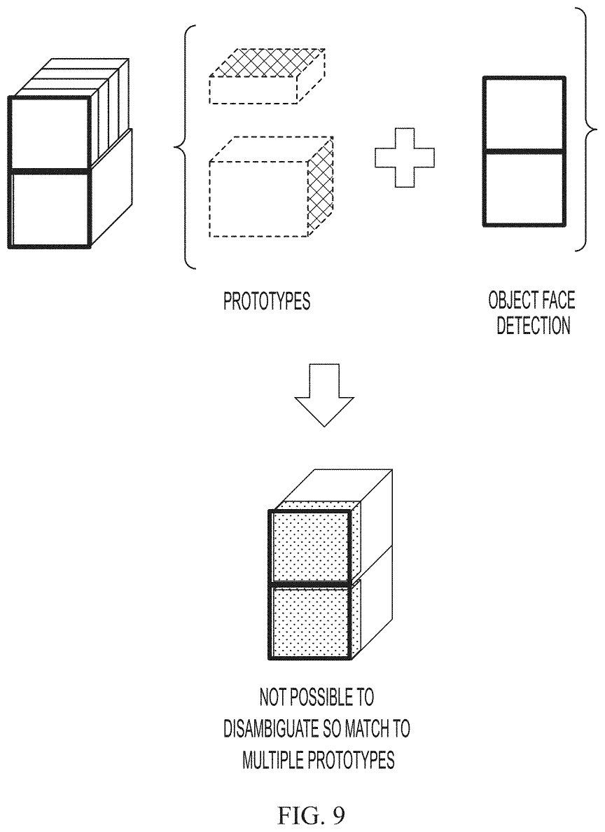

In some instances, multiple prototypes may match a same detected object face, an example of which is shown in FIG. 9. In such a scenario, the object face may be associated with multiple prototypes and interactions between all of the possible prototype matches, described in more detail below, may be modeled when determining which object to select next for extraction.

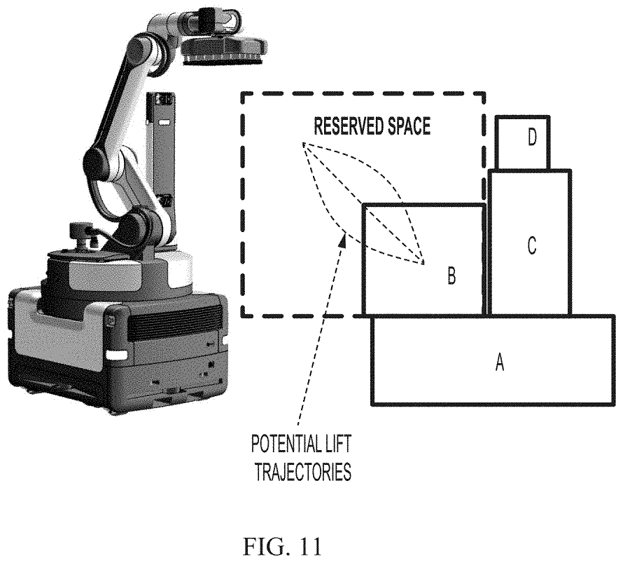

As described above, the three-dimensional model output from process 700 shown in FIG. 7 is a three-dimensional model of a stack of objects in which at least some of the objects in the stack are associated with a prototype from the set of stored prototypes. The three-dimensional model may be used, at least in part, to determine which object in the stack to select for picking next by the robotic device. In some embodiments, when multiple prototypes match a same detected object face, the three-dimensional model of the stack of objects may associate each of the multiple prototypes with the detected object face, and one of the multiple prototypes may be used at different stages of the process for selecting a target object to pick next. For instance, the prototype object with the shortest depth dimension may be assumed for grasping, whereas the prototype object with the longest depth dimension may be assumed for collision avoidance, as discussed in FIG. 11 below.

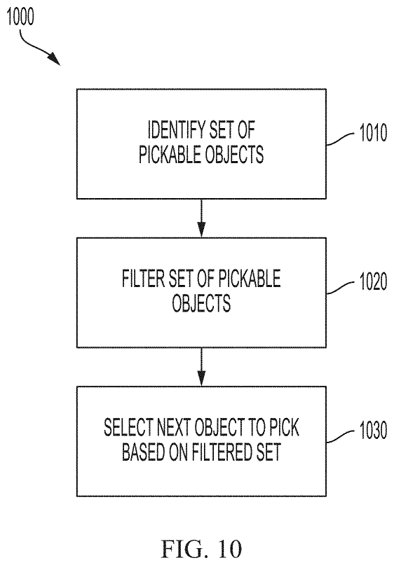

FIG. 10 illustrates a process 1000 for selecting a target object to pick next by a robotic device based on dependencies between objects in the stack, in accordance with some embodiments. In act 1010, a set of pickable objects is determined, for example, based on the three-dimensional model output from process 700 of FIG. 7 (e.g., the three-dimensional model shown in FIG. 8F). Process 1000 then proceeds to act 1020, where the set of pickable objects is filtered to generate a filtered set of pickable objects. In some embodiments, interactions between objects in the stack may be modeled to determine dependencies between neighboring objects. For instance, a first object in the stack may be considered to be dependent on a second object in the stack if moving the first object is dependent on moving the second object prior to moving the first object. In a simple example illustrated in FIG. 11, objects located below other objects are dependent on the objects located above them in the stack such that any object located above another object should be extracted before extracting the object below it. Other conditions may also be modeled and used to determine whether two objects are likely to interact with each other, examples of which are described in more detail in connection with FIG. 11.

Factors other than object dependencies may additionally or alternatively be taken into account when generating the filtered set of objects in act 1020. For instance, when a previous extraction of an object failed, a hold may be placed on extracting the object, which enables the robot to remember that there was a previous issue with extracting that object from the stack. Objects with holds placed on them may not be included in the filtered set and as such may not be considered for extraction. Object extraction issues can arise for various reasons including, but not limited to, the extraction force exceeding a threshold which indicates that the object is stuck, motion planning during extraction fails, poor suction with the object is detected, or a timeout value to complete extraction is exceeded. In some embodiments, one or more conditions may occur that result in a hold placed on an object being removed. For example, such conditions include, but are not limited to, a threshold number of other objects having been extracted from the stack, enough time having passed since the hold was placed, neighboring objects that likely caused the extraction issue having been extracted, or there being no other feasible objects to extract from the stack (e.g., the filtered set of objects is empty but for removing one or more holds placed on objects in the stack).

After generating a filtered set of objects (e.g., by eliminating from the original set of objects all objects that are dependent or are otherwise likely to interact with other objects if extracted), process 1000 proceeds to act 1030, where a next object to pick (also referred to herein as a “target” object) is selected based on the filtered set. In some instances, the filtered set of objects may include only a single object in which case that object is selected. In other instances, multiple “non-interacting” objects that could be picked from the stack may be included in the filtered set of objects and one or more heuristics or rules may be used to select one of the objects in the filtered set as the target object. For instance, the object in the filtered set that is closest to the robot may be selected as the target object. If there are multiple objects in the filtered set located at a same or similar distance from the robot, the tallest object may be selected as the target object. It should be appreciated that other criteria may additionally or alternatively be used to select an object from the filtered set as the target object, and embodiments are not limited in this respect.

As discussed above, a filtered set of objects may be created, at least in part, on interactions (or likely interactions) between different objects in the stack. FIG. 11 schematically illustrates how objects in a stack may be evaluated for likely interactions with other objects. As discussed briefly above, dependencies may be formed between objects when one object needs to be extracted before another object. If cyclic dependencies are created (e.g., object A depends on object B, which depends on object C, which depends on object A), a relaxation of dependencies may be required to enable one of the objects to be selected.

FIG. 11 illustrates a stack of four objects labeled A, B, C and D. In this simplified example, object A is dependent on objects B, C and D, and object C is dependent on object D. Accordingly, based on their dependencies, objects A and C would not be included in the filtered set of objects for possible extraction, leaving objects B and D for possible extraction candidates.

In some embodiments, possible extraction motions to extract a candidate target object from the stack may be considered when generating a filtered set of objects for extraction. For instance, kinematic and dynamic extraction models may be used to determine whether there are any likely interactions between a potential object for extraction and one or more other objects in the stack or other obstructions in the environment of the robot (e.g., truck walls or ceiling).

FIG. 11 shows an example of use of such a kinematic and dynamic extraction model to generate a filtered set of objects for extraction. The inventors have recognized and appreciated that a common extraction motion for extracting an object from a stack of objects is to move the object both upward and towards the robot after removal from the stack. To this end, a kinematic and dynamic extraction model may consider a particular amount of “reserved space” above and toward the robot, which represents a volume through which the object is likely to pass when extracted. The reserved space may be determined, at least in part, on one or more potential lift trajectories generated by the robot as shown in FIG. 11. In the example scenario of FIG. 11, both object B and object D may have sufficient reserved space to enable it to be picked from the stack. Accordingly, both object B and object D may be included in the filtered set of objects for extraction. In this example, object B may be selected as the next target object for extraction due to it being located closer to the robot and therefore easier to reach than object D.

As discussed above, some target objects when selected for extraction may be manipulated by the robotic device to enable a determination of a missing dimension (e.g., the depth dimension) of the object to be able to create a new prototype for the object. Having full dimension information (e.g., width, height, depth) for objects facilitates gripper placement on the object, object pick order determination and collision avoidance, among other things. For instance, as discussed in more detail below, having full dimension information for a picked object may facilitate how the robotic device places the picked object on a pallet, conveyor or other object.

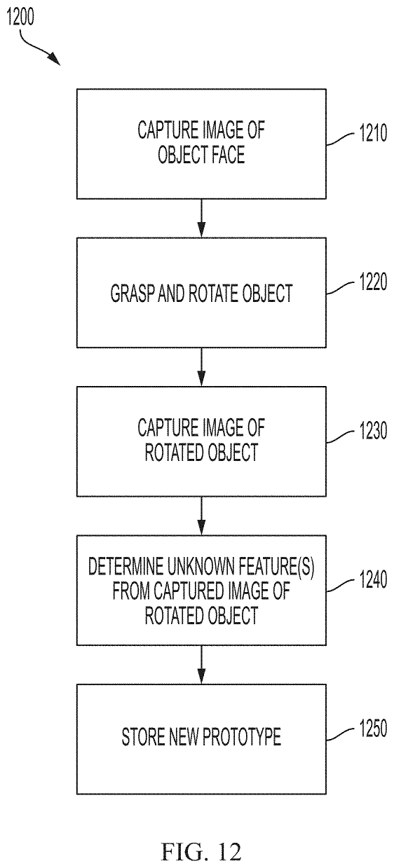

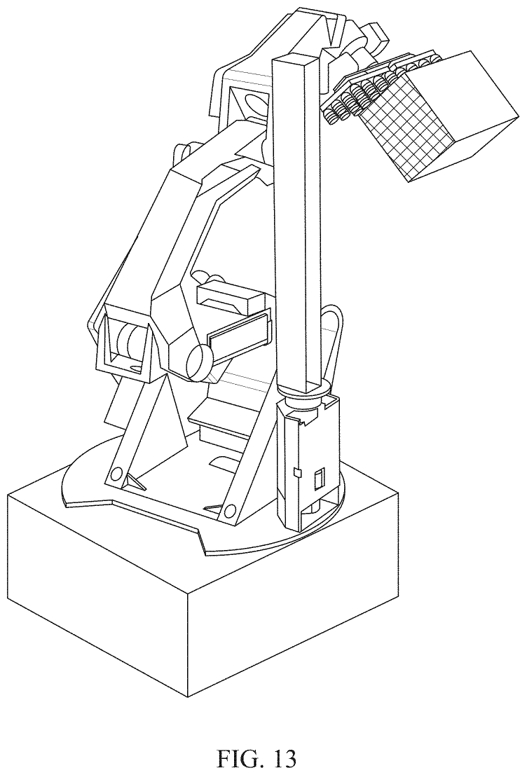

FIG. 12 is a flowchart of a process 1200 for determining a missing dimension (or other feature) of an object to generate a prototype of the object in accordance with some embodiments. Process 1200 begins in act 1210, in which an image of the object face is captured. For instance, an RGBD image of the front face of the object may be captured by a perception system of the robot and the front face of the object may be detected from the captured image. Having an image of the front face of the object informs the robot about, for example, the width and height of the object as well as feature descriptors for the object including, but not limited to, texture and color information. Process 1200 then proceeds to act 1220, in which the robot is controlled to grasp the object. The robot is then controlled to rotate the object to enable the perception system of the robot to capture an image of the face of the robot having one or more unknown (e.g., depth) dimension(s) or face textures. An example of executing a grasp and rotate operation is shown in FIG. 13, in which the grasped object has been rotated so a face of the object from which the unknown dimension can be measured is located in front of the perception system (e.g., located on a perception mast). Process 1200 then proceeds to act 1230, where an image of the rotated object is captured by the perception system. Process 1200 then proceeds to act 1240, where the captured image is processed to determine one or more unknown dimensions for the grasped object and feature descriptors (e.g., color, texture) for the face and/or object are determined. After determining the unknown dimension, process 1200 proceeds to act 1250 where a new prototype of the object is generated and added to the set of prototypes, as described above in connection with process 700 of FIG. 7.

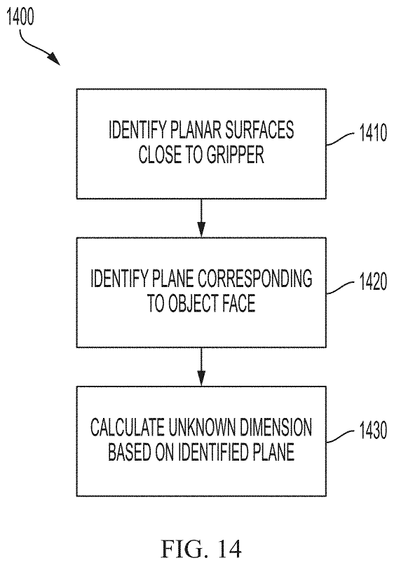

FIG. 14 is a flowchart of a process 1400 for processing an image of a grasped rotated object to determine an unknown dimension (e.g., act 1240 of process 1200) in accordance with some embodiments. Process 1400 begins in act 1410, in which planar surfaces in the general proximity of the gripper are identified in the captured image of the rotated object. Because the captured image shows the rotated object being grasped by the robot, searching for planar surfaces near the gripper can facilitate planar surface identification, as the gripper can be located near where the object is expected to be in the image. The planar surfaces may be identified in any suitable way. In some embodiments, the planar surfaces in the image are identified using a region growing technique in which neighboring pixels in the image that have similar normals are clustered together into a region. Other segmentation techniques, such as machine learning approaches, may alternatively be used. Process 1400 then proceeds to act 1420, where the segmented plane corresponding to the object face having the unknown dimension (e.g., depth) is identified. In some embodiments the segmented plane of interest is determined as the largest plane that is roughly parallel to the camera axis and that is in the front of the center of the gripper. Process 1400 then proceeds to act 1430, where the unknown dimension is calculated based on the segmented plane identified in act 1420. In some embodiments, the unknown dimension is calculated by fitting a rectangle to the identified segmented plane and calculating the unknown dimension as the length of the side of the rectangle corresponding to direction of the unknown dimension.

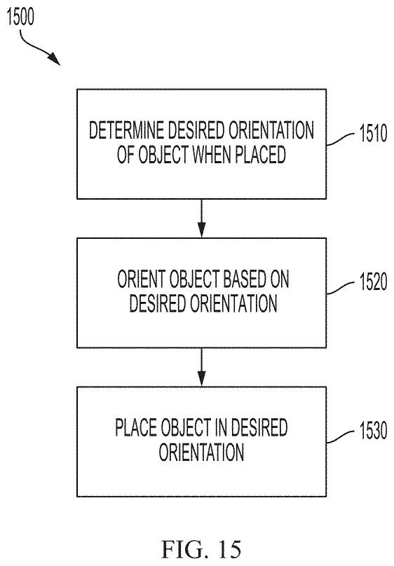

After an object is grasped by a robot, the robot may determine how to place the object at a target location (e.g., on a conveyor, cart, or pallet). The orientation of the object when placed at the target location may impact, for example, the stability of the object when placed. Accordingly, placing objects at a target location using a desired orientation (e.g., top side up, smallest size face up, long side face down, etc.) may be important to help ensure that the object is placed in a manner that ensures or facilitates stability of the object when placed at the target location. FIG. 15 is a flowchart of a process 1500 for placing an object with a desired orientation in accordance with some embodiments. In act 1510, a desired orientation of an object grasped or selected to be grasped by a robot is determined.

In some instances, the desired orientation of the object may depend, at least in part, on a particular task that the robot is performing. For example, when tasked with unloading boxes from a truck onto a conveyor, it may be desirable to place the long axis of the box on the surface of the conveyor to facilitate stable placement of the box on the conveyor surface. In some instances, the desired orientation of the object may depend on one or more characteristics of the object. For example, if the object is a box that includes fragile components (e.g., glassware), the desired orientation may be to keep the box in the same orientation (e.g., top up) as it was oriented in the stack to avoid breaking its contents (e.g., by flipping it sideways or upside down). Determining whether an object should be placed top up, for example, due to it containing fragile contents, may be performed in any suitable way. For instance, one or more prototypes associated with object may include information about the object that may be used to determine that the object should be placed top up. In some embodiments, information about the contents of the object may be determined, at least in part, based on a label (e.g., a barcode, a product label, etc.) on the object, and a determination that the object should be placed in a top up orientation may be based on identifying the label. Information about the contents of the object may also be used in some embodiments to change one or more operating parameters (e.g., arm speed, arm acceleration) of the robot.

As another example, the desired orientation may be determined based, at least in part, on an estimated stability of an object when placed at a target location. In some embodiments, the stability of the object when placed, for example, on a conveyor may be estimated based on information about the object including its dimensions and/or weight distribution (e.g., center of mass). For instance, the stability of the object when placed may be estimated by calculating a ratio of the sides of the object. Based on the calculated ratio, it may be determined whether placement of the object with its longest axis aligned with the surface of the conveyor will result in a stable placement and as such, should be the desired orientation. In some embodiments, the stability estimate may include factors other than or in addition to the dimensions of the object. For example, in some embodiment, a moment of inertia associated with the object may be used, at least in part, to estimate stability of the object when placed.

In some embodiments, multiple of the above factors (or additional factors) may be taken into consideration when determine a desired orientation of an object to be placed by a robot. For instance, although it may generally desirable to place an object on a conveyor with its longest dimension in line with the conveyor and its bottom face parallel with the conveyor plane, when the object includes fragile contents and/or if the object has an uneven weight distribution, an orientation other than long side down (e.g., a top up orientation) on the conveyor may be preferable. In some instances, a top up orientation of the object may be achieved while also rotating the object such that the bottom surface of the object is oriented to facilitate stability on the conveyor surface (e.g., by placing the longest of the bottom surface dimensions along the length of a conveyor surface).

After the desired orientation of the object is determined, process 1500 proceeds to act 1520, where the object is oriented (e.g., by movement of the robotic arm) based, at least in part, on the desired orientation. For example, the robot may determine a trajectory that results in the object arriving at the target location in the desired orientation. As described herein, the trajectory may also be determined, at least in part, to avoid collisions with other objects in the environment of the robot (e.g., truck walls, other objects, a conveyor). The orientation of the grasped object in the gripper of the robot may be included in the determined trajectory to ensure that the object arrives at the target location in the desired orientation and that any constraints (e.g., keeping the object with a top up orientation during the trajectory) associated with the trajectory are satisfied. Process 1500 then proceeds to act 1530, where the grasped object is placed at the target location in the desired orientation. For instance, the grasped object may be released from the gripper of the robot such that the object is placed at the target location.

As described above, when the target location of an object trajectory is associated with a conveyor coupled to or located near the robot, it may be desirable to orient the object such that its longest dimension is in line with the conveyor and the bottom face of the object is parallel with the conveyor plane. Such an orientation may facilitate stable placement of the object on the conveyor by ensuring that a large surface area of the object is placed in contact with the surface of the conveyor and/or that the object is placed in a manner to reduce overhang of the object relative to the conveyor surface.

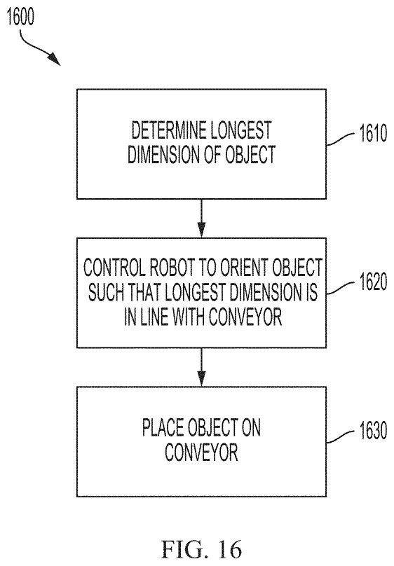

FIG. 16 is a flowchart of a process 1600 for placing an object on a conveyor such that its long axis is aligned with the plane of a conveyor. In act 1610, the longest dimension of an object grasped by the robot or selected to be grasped by the robot is determined. In some embodiments, the longest dimension of the object may be determined based, at least in part, on the prototype(s) associated with the object that was used to select the object for picking. For example, as described above, a 2D face of an object may be matched to one or more prototypes of 3D objects to generate a 3D model of a stack of objects in the environment of the robot. When multiple prototypes (e.g., having similar face dimensions but different depth dimensions) are determined to match the object face, a first prototype of the matching prototypes may be selected as the “most likely” prototype and a second prototype of the matching prototypes (e.g., the prototype with the largest depth) may be selected as the “worst case” prototype. For instance, the most likely prototype may be determined based on examining the position of the object in the stack relative to other objects and facades as described in connection with FIGS. 8A and 8B. Although it may be possible to disambiguate between the multiple prototypes by grasping the object and rotating it to determine the depth dimension (e.g., as described in connection with the processes shown in FIGS. 12 and 13), implementing such a process slows down the operation of the robot and may not need to be performed in all instances. Rather, at least some of the multiple matching prototypes (e.g., the first and second prototypes) may be used by the robot for different purposes. For instance, the first prototype may be used to generate the 3D model of the stack and the second prototype may be used for collision avoidance, as described herein. The inventors have recognized and appreciated that the dimension information included in prototypes may be used to determine a longest dimension of the object, which may in turn be used to place the object in a desired orientation after it has been grasped. In some embodiments, the longest dimension of the object is determined using the “most likely” prototype associated with the object. It should be appreciated that another prototype (e.g., the worst case” prototype) may be used for other purposes (e.g., collision avoidance).

Process 1600 then proceeds to act 1620, where the robot is controlled to orient the object such that the longest dimension of the object in line with the conveyor. The robot may be controlled to orient the object into a desired orientation (e.g., with the longest dimension of the object in line with the conveyor) at any point in time after the robot has grasped the object and before the object is placed on the conveyor. For instance, the robot may be controlled to orient the object into the desired orientation immediately or soon after picking the object, but prior to moving the arm of the robot through a trajectory from a start location (e.g., near where the object is picked) to a target location (e.g., above the conveyor). Alternatively, the robot may be controlled to orient the object into the desired orientation only after it has reached the target location. In yet further instances, the robot may be controlled to orient the object into the desired orientation as the arm of the robot is moved from the start location to the target location. In such instances, orientation of the object into a desired orientation may be integrated with the trajectory planning and execution processes of the robot to ensure smooth pick and place operation of the robot while avoiding collisions with other objects in the robot's environment.

Process 1600 then proceeds to act 1630 where the grasped object is placed on the conveyor in the desired orientation (e.g., longest dimension oriented in line with the conveyor). In some embodiments, how the object is placed on the conveyor may be determined based, at least in part, on information about possible collisions between the object and the conveyor. As described above, in some embodiments, multiple prototypes may be associated with an object being manipulated by a robot. Whereas the most likely prototype may be used for operations such as grasp placement and dimension determination, the worst case prototype may be used for collision avoidance. One of the objects to be avoided for collision modelling may be the conveyor on which the object is to be placed. To ensure that the object does not collide with the conveyor when the worst case prototype indicates that the object may have a relatively long dimension, the target location may be located some distance from the surface of the conveyor to ensure adequate clearance during the trajectory. To facilitate stable placement of the object on the conveyor, the robot may be controlled to execute a “gentle placement” of the object on the conveyor. For instance rather than merely dropping the object from distance, which may result in the object falling off of the conveyor and/or cause damage to the contents of the object, the robot may be controlled to gently lower the object toward the conveyor (e.g., in its desired orientation) prior to releasing its grasp on the object. In some embodiments, a gentle placement may be achieved by tipping the object forward (or backward) prior to releasing its grasp on the object. Tipping the object relative to the conveyor surface reduces the distance between the conveyor surface and a portion of the object that will contact the conveyor surface first.

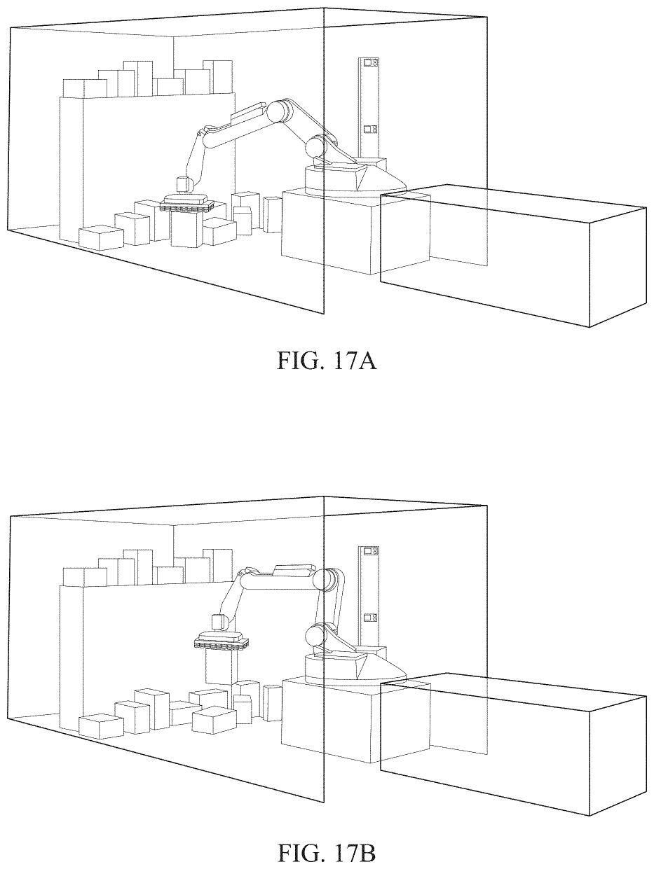

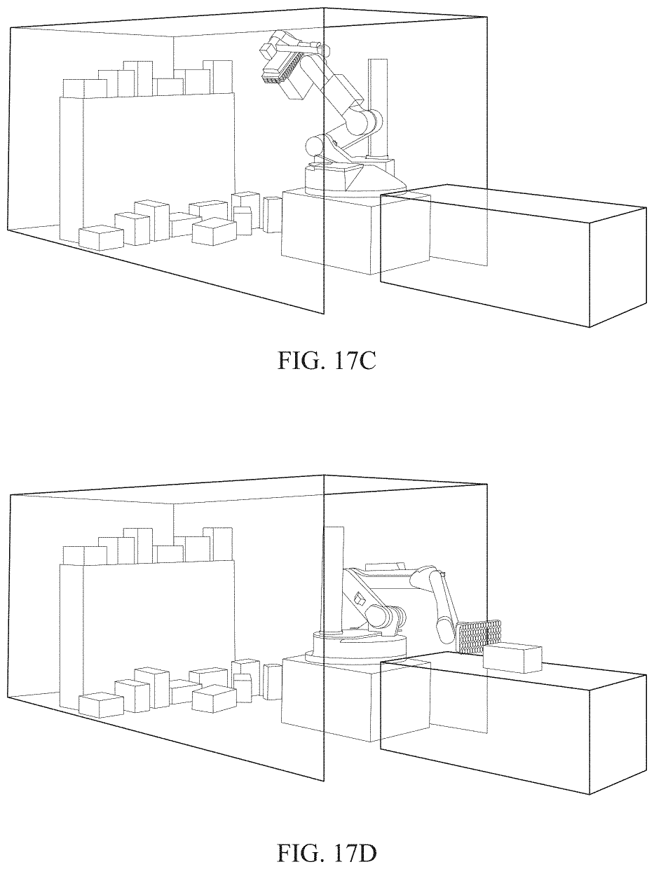

FIGS. 17A-17D depict a first sequence of frames of a simulation in which a robotic device grasps an object from within a container in which it is operating and places it on a conveyor with its longest dimension parallel to the surface of the conveyor in accordance with some embodiments. In FIG. 17A, the robotic device grasps an object located on the floor of the container by executing a top pick. In FIG. 17B, the robotic device lifts the object from the floor of the container. In FIG. 17C, the robotic device rotates the grasped object to orient its longest dimension along the conveyor surface. In FIG. 17D, the robotic device places the rotated object on the surface of the conveyor in a desired configuration such that the object is oriented with its longest dimensional along the conveyor surface.

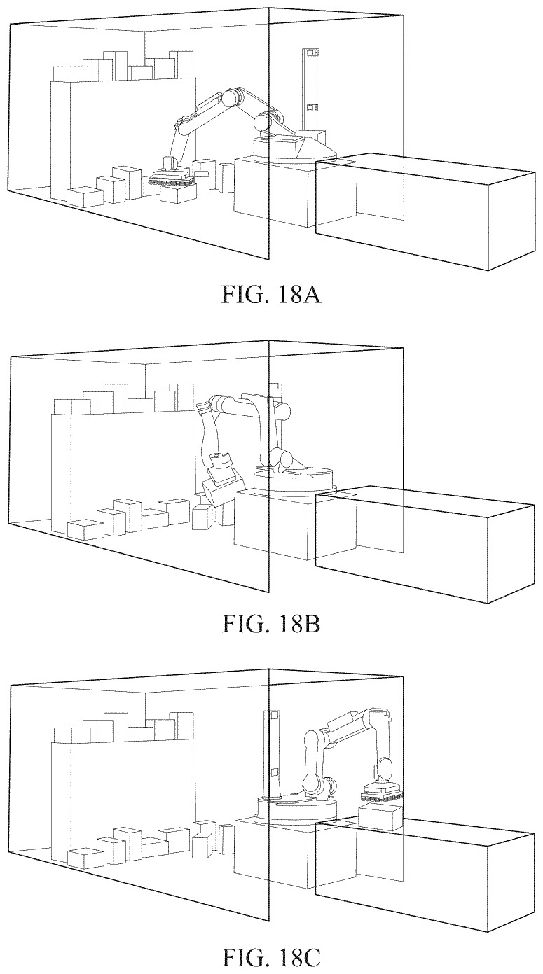

FIGS. 18A-18C depict a second sequence of frames of a simulation in which a robotic device grasps an object from within a container in which it is operating and places it on a conveyor with its longest dimension parallel to the surface of the conveyor in accordance with some embodiments. In FIG. 18A, the robotic device grasps an object located on the floor of the container by executing a top pick. In FIG. 18B, the robotic device lifts and rotates the grasped object to orient its longest dimension along the conveyor surface. In FIG. 18C, the robotic device places the rotated object on the surface of the conveyor in a desired configuration such that the object is oriented with its longest dimensional along the conveyor surface.

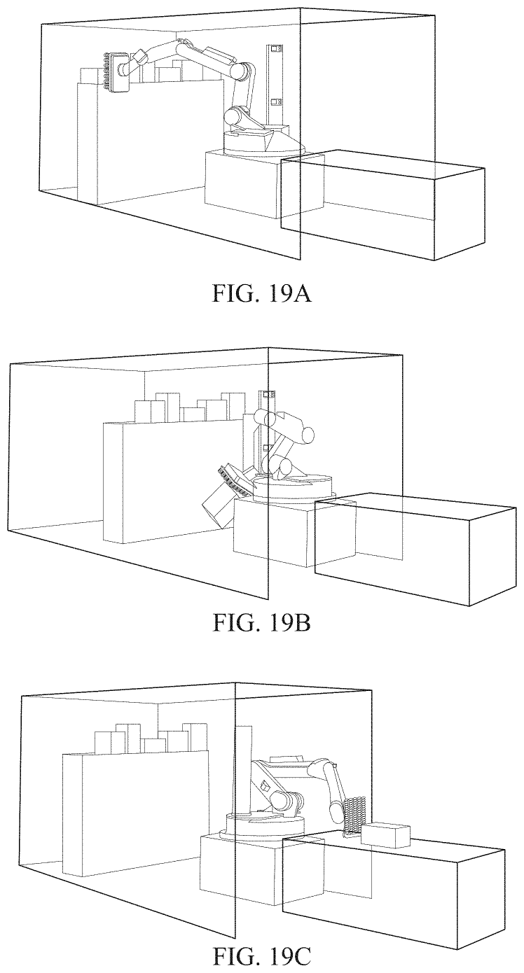

FIGS. 19A-19C depict a third sequence of frames of a simulation in which a robotic device grasps an object from within a container in which it is operating and places it on a conveyor with its longest dimension parallel to the surface of the conveyor in accordance with some embodiments. In FIG. 19A, the robotic device grasps an object located on the top of stack of objects by executing a face pick. In FIG. 19B, the robotic device lifts and rotates the grasped object to orient its longest dimension along the conveyor surface. In FIG. 19C, the robotic device places the rotated object on the surface of the conveyor in a desired configuration such that the object is oriented with its longest dimensional along the conveyor surface.

Although illustrated as separate elements, the modules described and/or illustrated herein may represent portions of a single module or application. In addition, in certain embodiments one or more of these modules may represent one or more software applications or programs that, when executed by at least one computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally, or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that embodiments of a robot may include at least one non-transitory computer-readable storage medium (e.g., a computer memory, a portable memory, a compact disk, etc.) encoded with a computer program (i.e., a plurality of instructions), which, when executed on a processor, performs one or more of the above-discussed functions. Those functions, for example, may include control of the robot and/or driving a wheel or arm of the robot. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

What is claimed is:

1. A method of generating a model of objects in an environment of a robotic device, the method comprising:
receiving, by at least one computing device, information about a plurality of two-dimensional (2D) object faces of the objects in the environment;
determining, by the at least one computing device, based at least in part on the information, whether each of the plurality of 2D object faces matches a prototype object of a set of prototype objects stored in a memory accessible to the at least one computing device, wherein each of the prototype objects in the set represents a three-dimensional (3D) object; and
generating, by the at least one computing device, a model of 3D objects in the environment using one or more of the prototype objects in the set of prototype objects that was determined to match one or more of the 2D object faces.

2. The method of claim 1, further comprising:
determining that a first 2D object face of the plurality of 2D object faces does not match any prototype object in the set of prototype objects;
creating a new prototype object for the first 2D object face that does not match any prototype object in the set; and
adding the new prototype object to the set of prototype objects.

3. The method of claim 2, further comprising:
controlling the robotic device to:
pick up the object associated with the first 2D object face; and
capture one or more images of the picked-up object,
wherein the one or more images include at least one face of the object other than the first 2D object face, and
wherein the new prototype object is created based, at least in part, on the captured one or more images of the picked-up object.

4. The method of claim 3, further comprising:
controlling the robotic device to rotate the picked-up object prior to capturing the one or more images of the picked-up object.

5. The method of claim 4, wherein creating the new prototype object based, at least in part, on the captured one or more images comprises:
identifying a first planar surface in a first image of the captured one or more images; and
calculating a dimension of the picked-up object based on the first planar surface, wherein the new prototype object includes the calculated dimension.

6. The method of claim 1, further comprising:
receiving user input describing prototype objects to include in the set of prototype objects; and
populating the set of prototype objects with prototype objects based on the user input.

7. The method of claim 1, further comprising:
receiving, from a computing system, input describing prototype objects to include in the set of prototype objects; and
populating the set of prototype objects with prototype objects based on the input.

8. The method of claim 1, further comprising:
determining a set of pickable objects based, at least in part, on the generated model of 3D objects;
selecting a target object from the set of pickable objects; and
controlling the robotic device to grasp the target object.

9. The method of claim 8, further comprising:
determining interactions between objects in the generated model of 3D objects and another object in the environment of the robotic device;
filtering the set of pickable objects based, at least in part, on the determined interactions; and
selecting the target object from the filtered set of pickable objects.

10. The method of claim 9, wherein determining interactions between objects in the generated model of 3D objects comprises:
determining which objects in the generated model have extraction constraints dependent on extraction of one or more other objects in the generated model, and
wherein filtering the set of pickable objects comprises including in the filtered set of pickable objects, only objects in the generated model that do not have extraction constraints dependent on extraction of one or more other objects in the generated model.

11. The method of claim 9, wherein determining interactions between objects in the generated model of 3D objects and another object is based at least in part on at least one potential extraction trajectory associated with the objects in the generated model.

12. The method of claim 11, further comprising:
determining a reserved space through which the at least one potential extraction trajectory will travel; and
including, in the filtered set of pickable objects, only objects in the generated model that have a corresponding reserved space in which no other objects are present.

13. The method of claim 9, further comprising:
determining based, at least in part, on the information, that a first 2D object face of the plurality of 2D object faces matches multiple prototype objects in the set of prototype objects, and
wherein determining interactions between objects in the generated model of 3D objects and another object comprises determining, for each of the multiple prototype objects matching the first 2D object face, interactions between the prototype object and another object.

14. A robotic device, comprising:
a robotic arm having disposed thereon, a suction-based gripper configured to grasp a target object;
a perception system configured to capture one or more images of a plurality of two-dimensional (2D) object faces of objects in an environment of the robotic device; and
at least one computing device configured to:
determine based, at least in part, on the captured one or more images, whether each of the plurality of 2D object faces matches a prototype object of a set of prototype objects stored in a memory of the robotic device, wherein each of the prototype objects in the set represents a three-dimensional (3D) object;
generate a model of 3D objects in the environment using one or more of the prototype objects in the set of prototype objects that was determined to match one or more of the 2D object faces;
select based, at least in part, on the generated model, one of the objects in the environment as a target object; and
control the robotic arm to grasp the target object.

15. The robotic device of claim 14, wherein the at least one computing device is further configured to:
determine that a first 2D object face of the plurality of 2D object faces does not match any prototype object in the set of prototype objects;
create a new prototype object for the first 2D object face that does not match any prototype object in the set; and
add the new prototype object to the set of prototype objects.

16. The robotic device of claim 15, wherein the at least one computing device is further configured to:
control the robotic arm to pick up the object associated with the first 2D object face; and
control the perception system to capture one or more images of the picked-up object, wherein the one or more images include at least one face of the object other than the first 2D object face, and
wherein the new prototype object is created based, at least in part, on the captured one or more images of the picked-up object.

17. The robotic device of claim 16, wherein the at least one computing device is further configured to control the robotic arm to rotate the picked-up object prior to capturing the one or more images of the picked-up object by the perception system.

18. The robotic device of claim 14, further comprising:
a user interface configured to enable a user to provide user input describing prototype objects to include in the set of prototype objects,
wherein the at least one computing device is further configured to:
populate the set of prototype objects with prototype objects based on the user input.

19. The robotic device of claim 14, wherein the at least one computing device is further configured to:
receive, from a computing system, input describing prototype objects to include in the set of prototype objects; and
populate the set of prototype objects with prototype objects based on the user input.

20. The robotic device of claim 14, wherein the at least one computing device is further configured to:
determine a set of pickable objects based, at least in part, on the generated model of 3D objects;
select a target object from the set of pickable objects; and
control the robotic arm to grasp the target object.

21. The robotic device of claim 20, wherein the at least one computing device is further configured to:
determine a desired orientation of the target object; and
place the target object in the desired orientation at a target location.

22. The robotic device of claim 21, wherein determining the desired orientation of the target object is based, at least in part, on the target location.

23. The robotic device of claim 22, wherein
the target location includes a conveyor, and
wherein determining the desired orientation of the target object comprises determining to align a longest axis of the target object with a length dimension of the conveyor.

24. The robotic device of claim 21, wherein the at least one computing device is further configured to:
determine a stability estimate associated with placing a side of the target object on a surface, wherein determining the desired orientation of the target object is based, at least in part, on the stability estimate.

25. The robotic device of claim 24, wherein determining the stability estimate comprises:
calculating a ratio of dimensions of the side of the target object; and
determining the stability estimate based, at least in part, on the ratio.

26. The robotic device of claim 21, wherein the at least one computing device is further configured to:
control the robotic arm to orient the target object based on the desired orientation.

27. A non-transitory computer readable medium encoded with a plurality of instructions that, when executed by at least one computing device, perform a method, the method comprising:
receiving information about a plurality of two-dimensional (2D) object faces of the objects in the environment;
determining, based at least in part on the information, whether each of the plurality of 2D object faces matches a prototype object of a set of prototype objects stored in a memory accessible to the at least one computing device, wherein each of the prototype objects in the set represents a three-dimensional (3D) object; and
generating a model of 3D objects in the environment using one or more of the prototype objects in the set of prototype objects that was determined to match one or more of the 2D object faces.
